(19) United States
(12) Patent Application Publication
(10) Pub. No.: US 2017/0147742 A1
(43) Pub. Date: May 25, 2017

(54) SYSTEMS AND METHODS FOR SYNTHETIC BIOLOGY DESIGN AND HOST CELL SIMULATION

(71) Applicant: NANYANG TECHNOLOGICAL UNIVERSITY, Singapore (SG)

(72) Inventors: Premkumar JAYARAMAN, Singapore (SG); Chueh Loo POH, Singapore (SG); Hui Juan WANG, Singapore (SG)

(21) Appl. No.: 15/321,739

(22) PCT Filed: Jun. 19, 2015
(86) PCT No.: PCT/SG2015/050169

§ 371 Date: Dec. 22, 2016

Related U.S. Application Data
(60) Provisional application No. 62/018,078, filed on Jun. 27, 2014.

(51) Int. Cl. G06F 19/12; C40B 30/02; G06F 17/11

(52) U.S. Cl. CPC G06F 19/12; G06F 17/11; C40B 30/02

(57) ABSTRACT

Systems and methods are proposed for synthetic biology design and host cell simulation. In one form, a synthetic biology design system is proposed, comprising a model conversion component configured to: receive genetic circuit data indicative of a user-specified genetic circuit design; identify, from the genetic circuit data, constituent parts of the genetic circuit design, and the connections between the constituent parts; obtain mathematical models corresponding to the constituent parts; and combine the obtained mathematical models into a composite model configured to generate genetic circuit output data based on input data indicative of one or more of: free RNA polymerase concentration, free ribosome concentration and rRNA concentration. The system further comprises a host cell simulation component configured to receive, as input, the genetic circuit output data from the composite model, and based on the genetic circuit output data, generate host cell output data representing a physiological state of the host.

### CROSS-REFERENCE TO RELATED APPLICATIONS

The present application is a filing under 35 U.S.C. 371 as the National Stage of International Application No. PCT/SG2015/050169, filed Jun. 19, 2015, entitled “SYSTEMS AND METHODS FOR SYNTHETIC BIOLOGY DESIGN AND HOST CELL SIMULATION,” which claims the benefit of U.S. Provisional Application No. 62/018,078 filed on Jun. 27, 2014, both of which are incorporated herein by reference in their entirety for all purposes.

### BACKGROUND

The present disclosure relates to the field of synthetic biology, and in particular to computational methods and systems for aiding in the design of gene circuits for synthetic biology.

By constructing new biological parts, devices or systems and reengineering cellular machineries and pathways, synthetic biology has created a paradigm shift in the fields of biology and biotechnology to serve specific objectives (1-3). Although the de novo engineering of biological pathways and processes has become possible (4, 5), the rational design of synthetic genetic circuits with predictable functions remains challenging. The daunting challenges confronted by biological engineers are: complexity, unpredictability and variable behaviour of the system that hosts the engineered designs. Inside the host chassis, a heterologous system depends directly or indirectly on the host's cellular resources and machineries for its function. This dependence on the cellular resources can impact the normal homeostasis of the host cell, inducing variable circuit behaviour or failure of the circuit inside the host interface (6).

Gene expression by heterologous systems places a burden on the host cell by depleting resources that are necessary for the host's normal function. Consequently, this would likely interfere with the key processes of the host cell, affecting its growth and other parameters. The impact of the burden mainly depends upon the circuit topology of the heterologous systems and the environment of the host cell (6). This coupling of the circuits to the host has been shown to generate physiologically important global effects on gene expression, which changes the state of the cell primarily by affecting the growth rate (7). Moreover, the production of unneeded heterologous proteins diverts cellular resources from synthesizing beneficiary host proteins thereby fractionally reducing the growth rate (8). It has been shown that, in Escherichia coli, growth halts completely as the concentration of unneeded protein approaches 30% of the total protein concentration (9). Understanding the intertwined relationship between the host cell and synthetic circuits is very important for biological engineers to improve the reliable predictions of synthetic circuitry behaviour.

One major challenge in elucidating various impacts on the host system due to the heterologous gene expression is the functional complexity of the host itself, as the system is dynamic, composed of many molecular species and reactions interconnected by regulatory mechanisms. As a result, it is difficult to predict the behaviour of synthetic circuits in the context of the host. Currently, synthetic circuit design often relies on trial and error redesigning, requiring extensive experimental evaluations that are laborious and time consuming (10). As a consequence, it is generally considered beneficial to have a mathematical and/or computational system model of the host cell. It is believed that this could mechanistically facilitate the design and evaluation of synthetic circuits (11). However, due to the lack of comprehensive whole cell models for organisms such as E. coli, many of the modelling efforts have so far been focussed on synthetic circuit design in isolation, or only incorporating limited host parameters (12, 13).

Recently Karr et al developed a whole cell model of Mycoplasma genitalium (an organism with a small genome) (14). Subsequently this model was used to demonstrate the impact of synthetic circuits on host cellular networks (10). However, the model is computationally intensive, comprising 28 independent sub-models, which makes it extremely challenging to scale up to larger organisms such as E. coli, one of the most commonly used hosts in synthetic biology.

It would be desirable to provide a host cell modelling system and genetic circuit design system which overcomes or alleviates one or more of the above problems, or at least provides a useful alternative to known systems.

### SUMMARY

Some embodiments of the present invention relate to a synthetic biology design system, comprising:
a model conversion component configured to:
   receive genetic circuit data indicative of a user-specified genetic circuit design;
   identify, from the genetic circuit data, constituent parts of the genetic circuit design, and the connections between the constituent parts;
   obtain mathematical models corresponding to the constituent parts; and
   combine the obtained mathematical models into a composite model configured to generate genetic circuit output data based on input data indicative of one or more of: free RNA polymerase concentration, free ribosome concentration and rRNA concentration; and
a host cell simulation component configured to receive, as input, the genetic circuit output data from the composite model, and based on the genetic circuit output data, generate host cell output data representing a physiological state of the host.

Some embodiments relate to a host cell simulation system, comprising:
a metabolism component for simulating amino acid and nucleotide production based on input stimulus data representing at least an input glucose concentration;
a transcription component for simulating mRNA and rRNA synthesis based on the simulated nucleotide production;
a translation component for simulating protein and RNA polymerase synthesis based on the simulated amino acid production; and
a replication component for simulating DNA synthesis based on the simulated nucleotide production;
wherein the RNA polymerase synthesis in the translation component is coupled to the rRNA synthesis in the transcription component.

Further embodiments relate to a synthetic biology design method, comprising:
receiving, at at least one computer processor, genetic circuit data indicative of a user-specified genetic circuit design;
identifying, by the at least one computer processor from the genetic circuit data, constituent parts of the genetic circuit design, and the connections between the constituent parts;
obtaining, by the at least one computer processor, mathematical models corresponding to the constituent parts;
combining, by the at least one computer processor, the obtained mathematical models into a composite model configured to generate genetic circuit output data based on input data indicative of one or more of: free RNA polymerase concentration, free ribosome concentration and rRNA concentration; and
inputting the genetic circuit output data from the composite model into a host cell simulation component to generate host cell output data representing a physiological state of a host cell.

Yet further embodiments relate to a host cell simulation method, comprising:
generating initial cellular resource data representing respective initial concentrations of free RNA polymerase, free ribosomes and ribosomal RNA;
receiving nutrient data representing at least a time-dependent glucose concentration; and
based on the nutrient data and the initial cellular resource data, determining output cellular resource data representing time-dependent concentrations of cellular resources of the host cell, the cellular resources comprising: free RNA polymerase; free ribosomes; ribosomal RNA; nucleotides; and amino acids.

### BRIEF DESCRIPTION OF THE DRAWINGS

Some embodiments of the invention will now be described, by way of non-limiting example only, with reference to the accompanying drawings in which:

FIG. 1 is a block diagram depicting the system architecture of an exemplary synthetic biology design system;

FIG. 2 is a block diagram of a host cell simulation module of the system of FIG. 1;

FIG. 3 is a block diagram showing a genetic circuit component coupled to a host cell simulation module;

FIG. 4 is a block diagram showing an alternative coupling between a genetic circuit component and a host cell simulation module;

FIG. 5 is a block diagram of an embodiment of a synthetic biology design system;

FIG. 6(A) is a schematic depiction of a virtual E. coli cell model;

FIG. 6(B) schematically depicts process flow and interactions in a host cell simulation using the model of FIG. 6(A);

FIGS. 6(C) and 6(D) are graphs of growth curves;

FIG. 7 is a flow diagram of an embodiment of a synthetic biology design process;

FIG. 8 is a flow diagram of a host cell simulation process;

FIG. 9 is a flow diagram of another example of a host cell simulation process, with a constitutive gene circuit incorporated;

FIGS. 10(A) to 10(C) are graphs showing growth rate reduction of wild-type E. coli Top10 grown in M9 supplemented media with varying glucose concentration and with different levels of rifampicin (6 μM, 8 μM & 10 μM), with simulation results generated by embodiments of a host cell simulation system, plotted with circles, and experimental results plotted with triangles (rifampicin) and squares (wildtype);

FIG. 10(D) is a graph of concentrations of free RNA polymerase as a function of growth rate for wildtype (circles) and different levels of rifampicin (6 μM—diamonds, 8 μM—squares and 10 μM—inverted triangles) predicted by embodiments of a host cell simulation system;

FIG. 10(E) is a graph of concentrations of ribosomal RNA during transcription inhibition as a function of growth rate for wildtype (circles) and different levels of rifampicin (6 μM—diamonds, 8 μM—squares and 10 μM—inverted triangles) predicted by embodiments of a host cell simulation system;

FIGS. 11(A to C) show growth rate reduction of wild-type E. coli Top10 grown in M9 supplemented media with varying glucose concentration and with different levels of tetracycline (1 μM, 2 μM & 4 μM); model results, shown as circles, correlate well with the experimental outcome, shown as inverted triangles, with average |r|=0.981;

FIG. 11(D) shows concentration of free ribosomes and FIG. 11(E) shows concentration of native bulk proteins during translation inhibition as predicted by embodiments of a host cell simulation system;

FIG. 12 shows predicted and measured effects of unnecessary protein production on growth by a constitutively expressed gene, under nutrient limiting conditions;

FIG. 13 shows predicted and measured effects of unnecessary protein production on growth by an inducibly expressed gene under limiting nutrient conditions;

FIG. 14 shows predicted effect of growth rate on bistable toggle switch circuit and induction threshold;

FIG. 15 is a demonstration of bistability under varying transcription rates;

FIG. 16 shows predicted repressilator dynamics under different growth conditions;

FIG. 17 shows growth and period of oscillations of a symmetric repressilator varying significantly with degradation rates;

FIG. 18 shows graphs of estimation of cellular composition under transcription inhibition in a host cell simulation system; (A) Concentration of free ribosomes; (B) ppGpp levels; and (C) Concentration of amino acids;

FIG. 19 shows graphs of estimation of cellular composition under translation inhibition; (A) Concentration of free ribosomes; (B) ppGpp levels; and (C) Concentration of amino acids;

FIG. 20 shows graphs of estimation of cellular composition under constitutive gene expression; (A) Concentration of free RNA polymerases; (B) ppGpp levels; (C) Concentration of amino acids;

FIG. 21 shows graphs of estimation of cellular composition under inducible gene expression; (A) Concentration of free RNA polymerases; (B) ppGpp levels; (C) Concentration of amino acids;

FIG. 22 shows time series RFP fluorescence by using constitutive device with varying promoter strengths;

FIG. 23 shows time series RFP fluorescence by using an inducible device with varying inducer concentrations;

FIG. 24 shows predicted effect of growth rate on bistable toggle switch circuit and induction threshold at external glucose=20 mM; (A to C) toggle switch dynamics under varying co-operativity of repression, n=2 (A); n=3 (B); n=4 (C). When the system is induced, the toggle switches in a quasi-discontinuous manner to the higher state (synthesizing opposing repressor 2 and inhibiting the active repressor 1). This state is maintained for higher inducer levels. The simulations were run with balanced rates of synthesis and degradation of the repressor mRNA and proteins. The active repressor 1 with the initial condition more the opposing repressor 2, completely inhibits its downstream expression. (D to F) Growth profiles of the cell under varying inducer levels. The growth of the cell predicted by the model varies during the toggle switching time;

FIG. 25 shows predicted effect of growth rate on bistable toggle switch circuit and induction threshold at external glucose=0.1 mM. (A to C) The plots show the toggle switch dynamics under varying co-operativity of repression, n=2 (A); n=3 (B); n=4 (C). When the system is induced, the toggle switches in a quasi-discontinuous manner to the higher state (synthesizing opposing repressor 2 and inhibiting the active repressor 1). This state is maintained for higher inducer levels. The simulations were run with balanced rates of synthesis and degradation of the repressor mRNA and proteins. The active repressor 1 with the initial condition more the opposing repressor 2, completely inhibits its downstream expression. (D to F) Growth profiles of the cell under varying inducer levels. The growth of the cell predicted by the model varies during the toggle switching time;

FIG. 26 shows predicted repressilator dynamics under different growth conditions. Period of oscillations in the level of the third repressor protein, as obtained from the model. For three different values of the co-operativity of repression, the repressilator was simulated inside the virtual cell at varying glucose concentrations to study the effect on growth and its oscillations (estimated by the distribution of the peak-to-peak intervals). Each of the simulation was run for only one generation;

FIG. 27 is a schematic depiction of a toggle switch circuit scheme; and

FIG. 28 is a schematic depiction of a repressilator circuit scheme.

### DETAILED DESCRIPTION

Here, we describe embodiments of a synthetic biology design platform in which the virtual cell model forms the core technology. The design platform may comprise a computational system integrated with an experimental toolkit (a library of physical, well-characterized, reusable bioparts) to facilitate rational engineering of novel biological systems. This addresses the need of a synthetic biology design platform that can aid industry and academic research groups to design and optimize genetic circuits and constructs, and perform in silico evaluation with respect to the feasibility of exogenous constructs, and their impact on the host system, prior to experimental work.

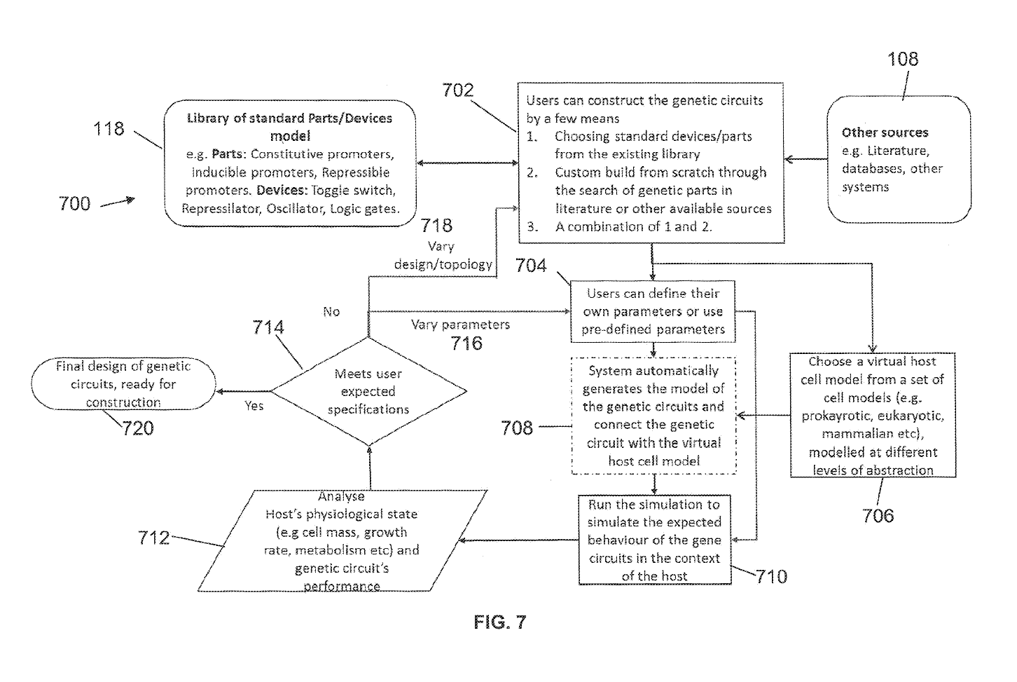

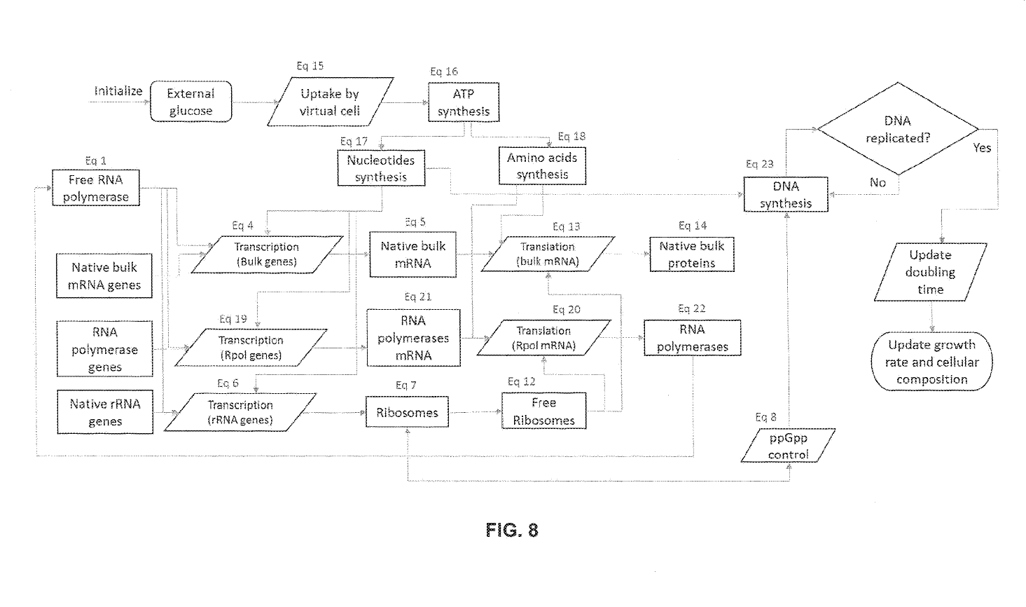

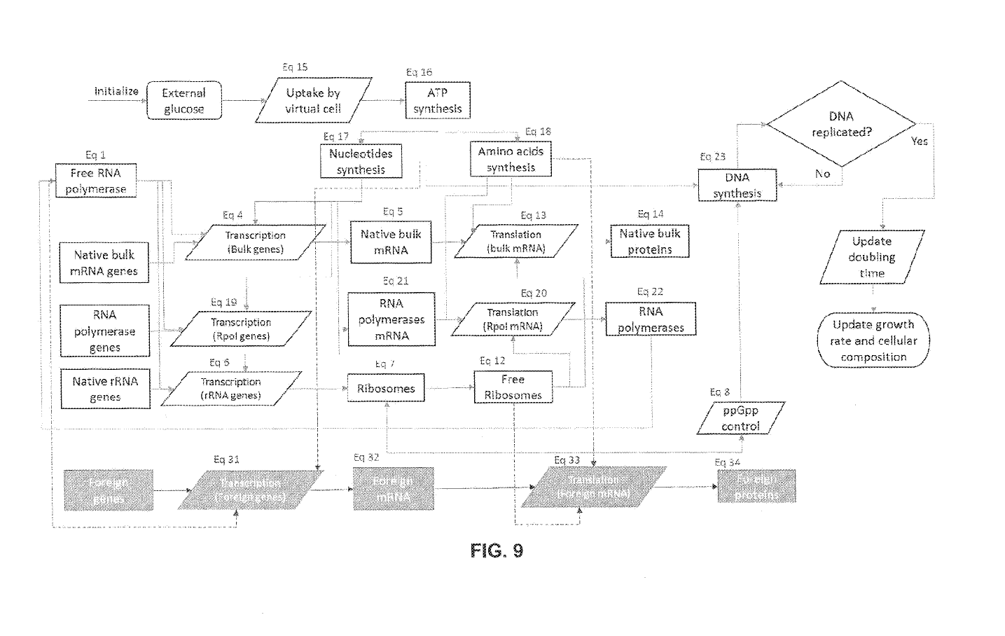

Referring initially to FIG. 1, there is shown a block diagram of an exemplary synthetic biology design system 100. The system 100 will in general be implemented as a computer system as described in more detail later. The computer system may be a single programmed computer, for example, or may be a plurality of networked computers or computer processors, with individual computers or computer processors being configured to carry out one or more operations in a synthetic biology design process 700 (FIG. 7). Various components of the system 100 may be implemented as software modules or components which interact with each other via the exchange of data, for example relating to time-dependent concentrations of biochemical species in a simulation of a cell. For example, a metabolism component may receive input signals relating to concentrations of external glucose, and produce output signals relating to concentrations of free amino acids and free nucleotides. The output signals may in turn be passed as input to other components, such as a transcription component which then produces an output signal comprising a concentration of an mRNA species, for example. In some embodiments, some or all of the components may be implemented in dedicated hardware, such as an ASIC, FPGA, or other special-purpose electronic component configured to carry out one or more operations of a synthetic biology design process.

The system 100 comprises a host cell simulation module 116 which can be communicatively coupled to one or more genetic circuit components. The host cell simulation module 116 may execute separately, under the control of a simulation control component 104. As will later be described, the host cell simulation module 116 may comprise a plurality of components for simulating various aspects of a host cell. The host cell simulation module 116 may receive input data, for example input stimulus data such as an input glucose concentration, and generate output data relating to concentrations of biochemical species, growth rate of the cell, and so on.

Alternatively, when the host cell simulation module 116 is coupled to a genetic circuit component, the simulation control component 104 may be configured to execute a host cell simulation in which resource demands of the genetic circuit are taken into account. For example, the host cell simulation module 116 may receive resource demand data from the genetic circuit component, indicative of required concentrations of biochemical species such as ribosomes, RNA polymerase, rRNA, nucleotides and amino acids.

Accordingly, the host cell simulation may provide insight to a user as to whether the genetic circuit may feasibly be implemented in a real biological system. For example, if the host cell simulation produces a cell growth rate which is unacceptably low, then the genetic circuit is unsuitable for implementation. The outputs from the simulation include the performance of the genetic circuit and the gene sequence of the gene circuit which can be used for actual construction and synthesis, for example using a DNA and/or RNA synthesizer such as a MerMade 192X synthesizer of BioAutomation Manufacturing (Irving, Tex.).

The system 100 comprises a user interface component which provides an interface to a genetic circuit graphical design component 102 and a simulation control component 104. The genetic circuit graphical design component 102 permits a user to specify, using an input device (for example, a mouse, keyboard, touchpad, touch screen, etc.) a genetic circuit (also known in the art as a synthetic biological circuit) layout. In general, a genetic circuit layout comprises biological parts such as genes, promoters and the like, together with connections between the parts. The circuit layout (e.g. identifiers for the parts, interactions between the parts, and interaction strengths) may be stored in a database, such as a parts and models registry database 118. The database 118 may be a local database resident on non-volatile storage of the system 100. Alternatively, it may be located on a database server which communicates with the system 100 over a communications network such as a LAN or WAN. Alternatively, the user could input the gene sequence maps of synthetic biological circuit design which the system 114 will automatically convert.

The simulation control component 104 may receive user input relating to simulation parameters (e.g. simulation time, or parameters of mathematical models corresponding to biological parts, such as transcription rate and translation rate for a virtual cell simulation, and may allow the user to control execution of the simulation. The simulation control component 104 may also output results of the simulation to a display device and/or may allow export of results 112 via an exporter component 110. The results may comprise the nucleotide sequence of the genetic circuit, parameters relating to the performance of the genetic circuit and/or the host cell, such as dynamic behaviour (growth rate and gene expression). In general, the output parameters may take the form of time series data, which may optionally be plotted and displayed to a user via the user interface component. The results 112 may also be stored in a database (not shown).

Using the lasQS device as an example, parameters such as association constant of AHL and LasR, transcription/translation rate of LasR and RFP respectively captured in the model parameters can be changed. For example, transcription rate relates to the promoter while translation rate relates to the ribosome binding site of RFP mRNA. The graphical design component 102 may provide an interface for the user to modify the parameter values. Similarly, the transcription rate and translation rate of LasR can also be modified in a similar manner for the user to study the behaviour of the lasQS device in silico.

In some embodiments, the system 100 may comprise an experimental toolkit 120 comprising a library of standard, well-characterized biological parts (bioparts) which design engineers can use to build the genetic circuits. These bioparts (e.g. promoters, ribosome binding sites and the like) are the fundamental building blocks of genetic circuits. Biopart data indicative of characteristics of these bioparts may be imported, using a parts and models converter 122 for example, and stored in the parts and models registry database 118. The biopart data comprises parameter values and other data, such as data relating to terms representing concentrations or derivatives of concentrations in differential equations of the model, for respective mathematical models for respective parts.

The parts and models converter 122 may include one or more components for enabling genetic parts and models to be converted from experimental results, and stored in parts and models registry 118. For example, experimental data from genetic parts characterization collated in standardized formats with metadata, such as from a microplate reader, may be analyzed to determine model parameters. These parameters, together with the metadata, can then be added into the parts database 118. In another example, the parts and models converter 122 may provide batch loading of multiple genetic parts into database 118 from parts datasheets. In a further example, known models of genetic circuits which are represented in other languages, such as SBML (System Biology Markup Language), may be converted into a format usable by the system 100 and stored in database 118. It is important to note that the term “model” is not limited by the number of genes or promoters; in fact, the system 100 may view an entire genome/organism scale pathway map as a large model.

Each biopart may have associated with it a standardized, modular mathematical model. Each biopart model may have standard inputs and outputs to enable connectivity with the host cell simulation module 116 and with each other, and to allow reusability in different genetic circuits, for example user-constructed genetic circuits generated by the graphical design component 102. In particular, each biopart model may have standard inputs in the form of respective concentrations of one or more biochemical species, such as free RNA polymerase concentration, free ribosome concentration and rRNA concentration, and may also have standard outputs in the form of respective concentrations of one or more biochemical species, such as free RNA polymerase concentration, free ribosome concentration, rRNA concentration, nucleotide concentration and amino acid concentration. For example, each biopart model may comprise one or more coupled differential equations which relate the input concentrations to the output concentrations, with coefficients for the various terms in the differential equations being obtained as further inputs (for example, by retrieval from the parts and models registry 118 or from the experimental toolkit 120).

In some embodiments, genetic circuit layouts input by a user in graphical form or gene sequences in formats like FASTA, GenBank format, via the genetic circuit graphical design component 102 may be automatically converted to data representing a mathematical model by a model conversion component 114. Each icon presented to the user by the graphical design component 102 may have a unique ID or tag which is mapped to an entry of the database 118. The model conversion component 114 may receive, from the genetic circuit graphical design component 102, data indicative of the genetic circuit layout, and may identify the constituent parts of the genetic circuit and the interactions and/or connections between them. The model conversion component 114 may then obtain, by querying database 118, mathematical models corresponding to the constituent parts, and combine the obtained models into a composite model by using the standardized inputs and outputs of the respective models. Each model for a biopart may be stored in class format in a standardized way, and may be populated with appropriate parameters from the corresponding entry for that biopart in the database 118. Once all parts have been retrieved from the database 118, they can be combined to form the composite model. For example, a simple composite model may comprise a promoter (pBAD), followed by a RBS and a gene of interest (e.g. green fluorescent protein). The generation of composite model can be performed automatically using an algorithm (part of model conversion component 114) which takes the models of bioparts and combines them to form the composite model. The combination of parts into composite model is based on inputs and outputs relationship using an object-oriented approach, in a similar manner in software programming. Each part model is considered as an object entity with inputs, outputs, and functions. The output of the algorithm would be a composite mathematical model representing the genetic circuits and other associated biochemical reactions (e.g. metabolic pathway). The algorithm is as follows:
1. Each individual part's model will have 0 or more inputs. For example, constitutive promoter will have 0 input but RBS will have 1 input (mRNA).
2. Each individual part's model will have 1 or more outputs, usually 1 output. For example, promoter will have mRNA as output.
3. Each individual part will have 0 or more named ODEs (currently, terminators do not produce ODEs).
4. Functions representing each part in the model will be individually generated. The functions will be written in programming language such as python. Take a LasR sensor (Construct: pTetR-RBS1-LasR-Term1) for example, the following ODE functions will be generated:
   a. mRNA_pTetR<random number>; for example, mRNA_pTetR21543, from pTetR
   b. peptide_RBS1<random number>; for example, peptide_RBS152643, from RBS1
   c. protein_LasR<random number>; for example, protein_LasR58474, from LasR
5. Each individual part's model will have its own output term(s) as a variable. For example, pTetR's output will be mRNA.
6. The output term(s) of the preceding part will be used as input into the succeeding part. For example, RBS1 takes the mRNA output from pTetR as input. This will be carried out until all the parts are connected based on inputs/outputs.
7. Interaction (e.g., binding of LasR and AHL to form a complex) will take 2 or more inputs to give 1 or more outputs. The interaction is represented in ODE(s). The promoter induced or repressed by the product of interaction will be presented in ODE by taking the interaction product as inducer or repressor. Then, variables in the ODE functions will be substituted accordingly. As a result, one or more BBB/inducer/interaction combinations are linked together using an interaction.
8. The end result is the formation of a model from individual parts representing the genetic circuits and associated biochemical reactions (e.g. metabolic pathway).

In some embodiments, the genetic circuits may be constructed using standard bioparts from an external data source, such as the parts defined in the Registry of Standard Parts (www.partsregistry.org). For example, an importer component 108 may receive biopart data from the external data source, such as XML data specifying the part characteristics and/or sequence data in FASTA format, and reformat the biopart data into a form suitable for storage in the parts and models registry database 118. The importer component 108 may communicate with and import data from other software, for example. In one example, annotated vector maps in raw Genbank format or from output from other software tools, such as Vector NTI, Geneious etc., can be converted into models of genetic circuits and deposited into the database 118. It is important to note that genetic circuits are not limited to engineered plasmid vectors but may also include entire genomes. For example, the system 100 may view an entire chromosome or genome as a highly complex genetic circuit. When vector maps are provided, importer component 108 may extract information of the constituent parts of the genetic circuit from the DNA sequences directly or through annotations. Identifying constituent parts directly from DNA sequences may require querying of databases (e.g. through the use of BLAST algorithm). The model conversion component 114 may take the information and automatically generate the model of the genetic circuits and associated biochemical reactions. This process may be triggered by the user via the genetic circuit graphical design component 102.

Once a composite model has been assembled for the genetic circuit, it can be combined with the host cell simulation module 116 for a host cell simulation process, in order to determine the impact of the genetic circuit on parameters of the host cell, such as growth rate. As shown in FIG. 3, a genetic circuit component 300 is configured to receive input data indicative of cellular resources (for example, concentrations of biochemical species output from the host cell simulation module 116), to process the input data according to the composite model, and to produce output data based on the processing. The output data are indicative of concentrations of biochemical species generated by the genetic circuit component 300, and are passed as input to the host cell simulation module 116. The output data from the genetic circuit may also comprise parameters relating to the performance of the genetic circuit. The output data from the host cell simulation module 116 may comprise data indicative of a physiological state of the host cell.

In one example, a genetic circuit component 300 and the host cell simulation module 116 may be coupled via the sharing of five cellular resources (biochemical species), in particular nucleotide, amino acid, free RNA polymerase, free ribosome and rRNA. For example, a foreign gene expression system can be represented as a genetic circuit component having four subsystems: (1) transcription part A; (2) transcription part B; (3) translation part A; (4) translation part B.

Transcription part A describes the initiation of transcription which is the binding between free RNA polymerase and promoter. This binding starts the synthesis of mRNA. Transcription part B models the elongation of mRNA.

Translation part A describes the initiation of translation which is the binding between free ribosome and mRNA. The binding starts the synthesis of proteins. Translation part B models the elongation of a protein peptide chain.

The genetic circuit component 300 may receive cellular resources from the host cell simulation module 116 in order to perform gene expression. In one example, these resources are: nucleotide (modelled in transcription part B, formation of mRNA) and amino acid (modelled in translation part B, formation of protein peptide chain). The genetic circuit component 300 also receives data relating to input cellular components for performing gene expression. These cellular components are: free RNA polymerase (modelled in transcription part A), free ribosome and rRNA (modelled in translation part A).

The host cell simulation module 116 shares cellular components (outputs to the genetic circuit component 300 and inputs from the genetic circuit component 300) which are also being used for its own transcription and translation, in particular free RNA polymerase, free ribosome and rRNA. ATP consumption in the host cell simulation module 116 may be estimated based on nucleotide and amino acid consumption.

The outputs and inputs that connect the genetic circuit component 300 and host cell simulation module 116 in this example are summarised in Table 1A.

TABLE 1A

| | Inputs | Outputs |
|---|---|---|
| Host cell simulation | free RNA polymerase | free RNA polymerase |
| module 116 | free ribosome | free ribosome |
| | rRNA | rRNA |
| | | Nucleotide |
| | | Amino acid |
| Genetic Circuits 300 | free RNA polymerase | free RNA polymerase |
| | free ribosome | free ribosome |
| | rRNA | rRNA |
| | Nucleotide | |
| | Amino acid | |

Inputs and/or outputs of the various components may be computed by way of coupled equations, such as coupled differential equations. One such series of computations is described in the section entitled “Exemplary mathematical models for host cell simulation and genetic circuits”, below.

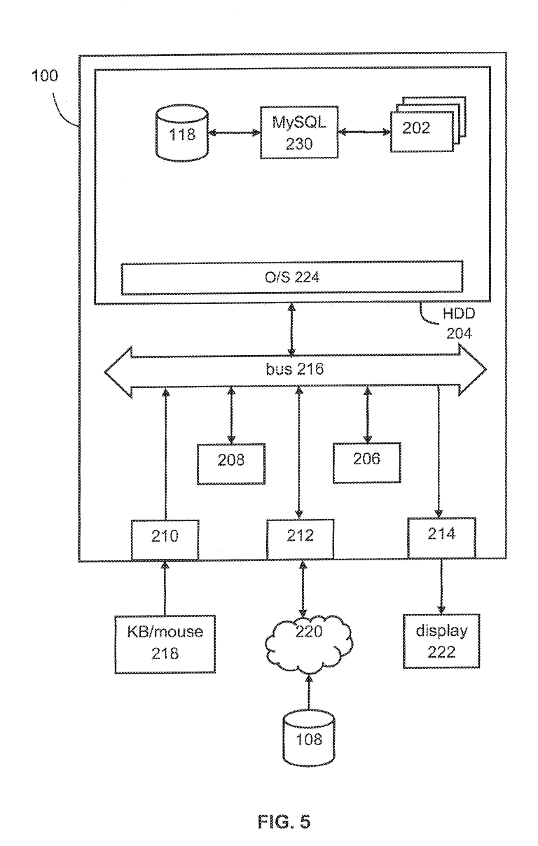

Referring now to FIG. 5, there is shown an exemplary computer system embodying the synthetic biology design system 100. The synthetic biology design system may be a standard computer system such as an Intel IA-32 based computer system 100, as shown in FIG. 5, and the associated simulation and design processes executed by the system 100 are implemented in the form of programming instructions of one or more software modules or components 202 stored on tangible and non-volatile (e.g., solid-state or hard disk) storage 204 associated with the computer system 100, as shown in FIG. 5. However, it will be apparent that the processes could alternatively be implemented, either in part or in their entirety, in the form of one or more dedicated hardware components, such as application-specific integrated circuits (ASICs), and/or in the form of configuration data for configurable hardware components such as field programmable gate arrays (FPGAs), for example.

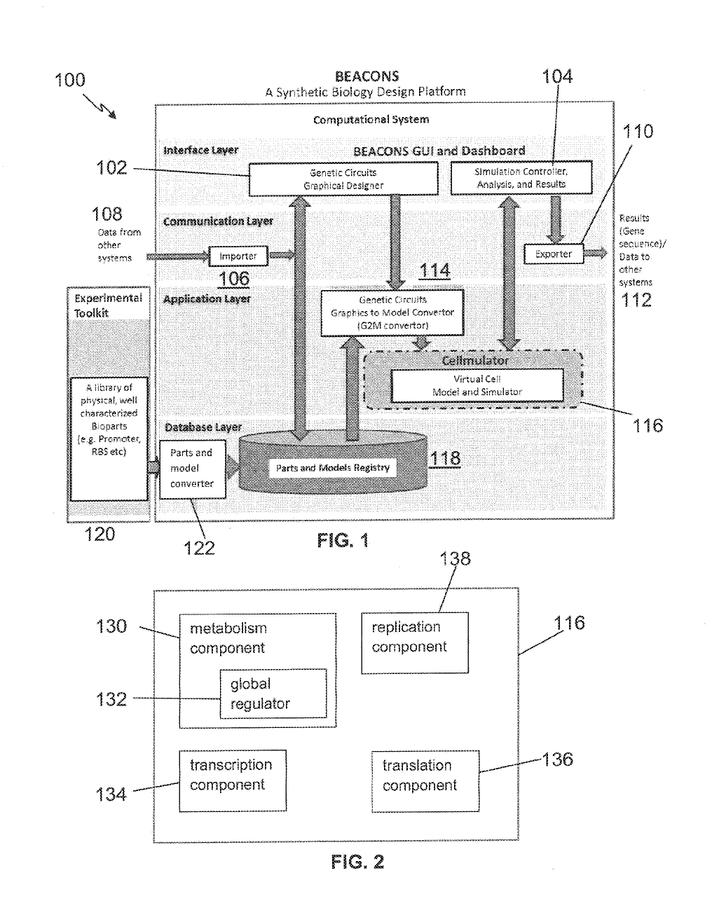

The software modules or components 202 comprising the software instructions for carrying out the host cell simulation processes and synthetic biology design processes may comprise the host cell simulation module 116, graphical design component 102, simulation control component 104, importer component 106, exporter component 110, model conversion component 114 (as shown in FIG. 1) and one or more genetic circuit components 300 (FIG. 3). As shown in FIG. 2, the host cell simulation module 116 may comprise a number of sub-components, such as a metabolism component 130 (which in turn may comprise a global regulator component 132), a replication component 138, a transcription component 134 and a translation component 136.

As shown in FIG. 5, the system 100 may include standard computer components, including random access memory (RAM) 206, at least one processor 208, and external interfaces 210, 212, 214, all interconnected by a bus 216. The external interfaces include universal serial bus (USB) interfaces 210, at least one of which is connected to a keyboard 218 and pointing device such as a mouse, and a network interface connector (NIC) 212 which connects the system 200 to a communications network 220 such as the Internet, via which an external database 108 containing bioparts data can be accessed by the system 100, for example.

The system 100 also includes a display adapter 214, which is connected to a display device such as an LCD panel display 222, and a number of standard software modules, including an operating system 224 such as Linux or Microsoft Windows. The system 200 may include structured query language (SQL) support 230 such as MySQL, available from http://www.mysql.com, which allows data to be stored in and retrieved from an SQL database 118, including data representing parameters and other mathematical model details for bioparts as described above.

FIG. 7 shows an exemplary workflow 700 involving the use of the system 100. At the beginning of the design process using the system, users can construct 702 genetic circuits using the system's graphical interface 102 by a few means. If the required devices and parts for the genetic circuit to be constructed are available in the library 118, the user can simply select devices/parts in the library 118 to construct the genetic circuit, for example by dragging and dropping selected parts onto a canvas and drawing connections between parts. Otherwise, the user can build the genetic circuit from scratch, for example based on searches of literature or other available data sources. Users can also directly import designs of their genetic circuits from other data sources 108.

After the user has constructed one or more genetic circuits using the graphical design component 102, the user can define, at step 704, their own parameter values for the models of the parts of the genetic circuit(s), or use pre-defined parameter values available in the library 118.

The system 100 may have a set of different virtual host cell models (e.g. prokaryotic, eukaryotic, mammalian etc.) which are modelled at different levels of abstraction to address different experimental questions. The virtual host cell models can include simple models having only key biological processes, or can include more complex genome scale models. At step 706 the user may select a particular host cell model, for example an E. coli host cell model as described below.

Once the user has constructed a genetic circuit, defined the parameters and chosen the host cell model, as described above the system 100 may then automatically generate the composite model of the genetic circuits (by model conversion component 114, for example) and connect the genetic circuit to the virtual host cell model—step 708. The user may then, via simulation component 104, run a simulation using the composite model to simulate the expected behaviour of the gene circuits in the context of the host—step 710. The simulation results will allow the user to analyse and interpret the host physiological state (e.g. cellular composition, cell mass, growth rate, metabolism etc.) and the genetic circuit performance—step 712. The user can check whether the genetic circuit performance meets their expectation, at step 714. If so, the user may indicate (via simulation control component 102, for example) that the performance is satisfactory, and the system 100 may generate, at step 720, the final design, comprising the nucleotide sequence and circuit topology, ready for actual construction. Otherwise, the user may fine tune the genetic circuits by changing the various parameters of the genetic circuits (step 716), or changing the topology of the genetic circuit (step 718). The system 100, via graphical design component 102, may provide a list of design rules to guide the user in this optimisation process 716, 718. The design rules may be stored in database 118 or in a separate database, and may include rules relating to which arrangements of biological parts should be included to replicate what is known in nature. For example, one of the rules may be that each circuit for a gene should contain at least one ribosome binding site upstream of the gene, and at least one promoter upstream of the ribosome binding site and the gene. The graphical design component 102 may alert the user, or may refuse to allow the design to be finalised, if one or more rules are violated. The simulation can then be re-run (712) and the fine tuning process can be repeated until a satisfactory design is achieved.

If the final design of the genetic circuit contains new synthetic parts that are not available in the experimental toolkit 120, forward engineering tools may be used to design synthetic parts which meet desired criteria. These forward engineering prediction tools may include predicting promoter strength from DNA sequences, translation rates from ribosome binding sites, and so on.

### Exemplary Mathematical Models for Host Cell Simulation and Genetic Circuits

The mathematical models embodied in the host cell simulation module 116 describe the four biological processes, metabolism, transcription, translation and replication and their interactions, to determine cellular parameters and growth. The models disclosed herein are based on ordinary differential equations to define the cellular processes accounting for bulk mRNA and protein synthesis, ribosomes, ppGpp, ATP, amino acids, nucleotides and DNA synthesis. However, other methods of modelling these processes are possible.

The initial conditions assumed were machineries such as free RNA polymerase with an initial concentration of 2.1 μM and free ribosomes of 4.1 μM to build the E. coli virtual cell (18), as in Table 2 below, which lists all of the initial conditions for parameters in the model. All the parameters used to build the virtual cell model 116 are listed in Table 3.

### Free RNA Polymerase Activity and Messenger RNA Synthesis

The native RNA synthesis in E. coli is modelled by equations describing the free RNA polymerase formation and its interactions with the bulk mRNA and rRNA promoters. Free RNA polymerase binds to free promoters forming an activated complex that can initiate transcription and elongates by adding nucleotides to form native RNAs. The following differential equation describes the rate of change of free RNA polymerase concentration, denoted fRa is given by their promoter binding action and their synthesis rate:

$$\frac{d}{d t} fRa ( t ) = 0.2 ( \frac{d}{d t} RNAP ( t ) ) - \frac{d}{d t} {PC}_{m} ( t ) - \frac{d}{d t} {PC}_{p} ( t ) - \frac{d}{d t} {PC}_{mr} ( t ) \qquad ( 1 )$$

The promoters can switch among two functional states: (i) bound to RNA polymerase forming an activated complex or (ii) free. The conservation of native promoters are given as:

Pₘ=PCₘ+fPₘ (2)

Pᵣ=PCᵣ+fPᵣ (3)

The free promoter is denoted as fpₘ & fpᵣ and PCₘ & PCᵣ are the promoters bound to RNA polymerase. The total mRNA_promoter concentration (Pₘ) grouped into constitutive, pause and repressible classes was given as 2.09 μM (19). The subscript ‘m’ and ‘r’ will be used for variables related to the mRNA and rRNA promoters. αₘ is the transcription rate of bulk mRNA which is given as 0.05 s⁻¹ (19), αᵣ=1.83 s⁻¹ (19, 20) is the rate of transcription of ribosomal genes.

The free RNA polymerase concentration was defined to be a smaller fraction of the RNA polymerase synthesised and this fraction increases with increasing growth rate due to the increased synthesis of RNA polymerase (21). Thus, the dynamic supply of free RNA polymerase was based on the approximated 20% of the total active RNA polymerases at any given time (19, 22), and is represented as 0.2 times RNA polymerase synthesized in our model. αₚ=0.07 s⁻¹ is the translation rate of bulk mRNA and is assumed to be similar for translating core RNA polymerase subunit mRNAs.

Free RNA polymerase-promoter complex formation is based on the promoter strength of mRNAs which can be represented as a kinetic equation below,

$$\frac{d}{d t} {PC}_{m} ( t ) = {k}_{1}^{f} \cdot {fP}_{m} ( t ) \cdot fRa ( t ) - ( {k}_{2}^{b} + {α}_{m} ) \cdot {PC}_{m} ( t ) \qquad ( 4 )$$

Where, k^{f}₁ & k^{f}₂=10⁶ M⁻¹ s⁻¹; k^{b}_{1=0.65} s⁻¹ & k^{b}₂=2.57 s⁻¹ are forward and backward rate constants for mRNA and rRNA transcription initiations respectively (19, 23, 24). The rate of change in concentration of bulk mRNA in the native system is given by their synthesis rate based on the RNA polymerase promoter complex formation and addition of nucleotides elongating the mRNA chain minus their degradation rate.

$$\frac{d}{d t} M ( t ) = {α}_{m} \cdot {PC}_{m} ( t ) \cdot {A}_{rp} - {β}_{m} \cdot M ( t ) \qquad ( 5 )$$

βₘ=2.9*10⁻³ s⁻¹ is the degradation rate of native mRNAs (7).

Where,

$${A}_{rp} = \frac{( \frac{N ( t )}{{K}_{N} + N ( t )} )}{( 1 + \frac{N ( t )}{{K}_{N} + N ( t )} )} ,$$

represents the fraction of actively transcribing RNA polymerases. The denominator in the equation for Aᵣₚ represents the proportions of ‘elongation complex’ site free combined with elongation complex with added nucleotide. The elongation complex with added nucleotide (numerator) is modelled using a Michaelis-Menten term that increases with free nucleotide concentration. ‘N’ is the free nucleotide concentration, and K_{N}=2 μM is the dissociation constant for nucleotides (25).
Ribosomal RNA, ppGpp and Bulk Protein Synthesis

We adapted the mathematical model by Marr (20) to describe the ribosome synthesis and its regulation in the virtual cell system. Similar to mRNA synthesis, free RNA polymerase binds to the rrn promoters forming an activated complex denoted as fPᵣ. The total rrn promoter concentration (Pᵣ) grouped into rrn P1 and P2 is 0.08 μM (19). The rrn P2 promoter is suggested as an unsaturated constitutive promoter and the factors that determine the activity of the promoter are the free RNA polymerase concentration availability and the stringent response effect due to nutrient starvation leading to increased ppGpp synthesis (21). It is also proposed that the exceptional high strength of the rrn P1 promoter could be caused by sequences outside the core promoter region, primarily in their upstream flanking sequences, and its activity could be strongly inhibited during the stringent response due to amino acid starvation (26).

$$\frac{d}{d t} {PC}_{r} ( t ) = {k}_{2}^{f} \cdot {fP}_{r} ( t ) \cdot fRa ( t ) - ( {k}_{2}^{b} + {α}_{r} ) \cdot {PC}_{r} ( t ) \qquad ( 6 )$$

The rate of change of ribosome concentration rRNA is given by the synthesis rate of ribosomes minus their degradation rate, as in Eq. (7).

$$\frac{d}{d t} rRNA ( t ) = {α}_{r} \cdot r \cdot {PC}_{p} ( t ) \cdot {A}_{rp} - {β}_{r} \cdot rRNA ( t ) \qquad ( 7 )$$

where, αᵣ=1.83 s⁻¹ is the maximum rate of transcription of ribosomal genes (19, 20). ‘βᵣ’, is the degradation rate of ribosomes and is assumed to be similar to that of the native bulk proteins.

$$‘ r ’ = ( \frac{{K}_{g}^{h}}{{K}_{g}^{h} + {G ( t )}^{h}} ) ,$$

represents the transcription resource allocation between ribosomal and non-ribosomal genes, which is a function of ppGpp (G).

The rate of transcription of ribosomal genes is controlled by the concentration of ppGpp (G) and is given as hill equation (20). K_{g}=40 μM is the dissociation constant for ppGpp and h=2 is the cooperativity of binding. ppGpp has direct effects on RNA polymerase promoter interaction and it has been shown that the rate of open complex formation of rRNA promoters has been affected by ppGpp (27).

The regulatory signal assumed in this model is the ppGpp concentration. The core assumption in this equation is that some of aminoacyl-tRNAs compete at the A-site with uncharged-tRNAs. Based on the availability of amino acid pools, aminoacyl-tRNAs add amino acids to the growing peptide chain and uncharged-tRNA inhibits the transcription of rrn operons (20). The rate of change in concentration of ppGpp (G) is modelled by its rate of synthesis minus the rate of its breakdown.

$$\frac{d}{d t} G ( t ) = {k}_{1} \cdot rRNA ( t ) \cdot {S}_{R} - {k}_{2} \cdot G ( t ) \qquad ( 8 )$$

Where, k₁=1 s⁻¹ and k₂=0.035 s⁻¹ are rate constants (20).

$${S}_{R} = ⌈ \frac{\frac{U}{{K}_{U}}}{( 1 + \frac{U}{{K}_{U}} + \frac{C}{{K}_{C}} )} ⌉ ,$$

represents the fraction of stalled ribosomes.

‘C’ and ‘U’ are the concentration of aminoacyl-tRNA and uncharged-tRNA, respectively and K_{C}=2.75 μM and K_{U}=10 μM are the respective dissociation constants. The denominator in the equation for S_{R} represents the proportions of ‘A’ site free, combined with uncharged-tRNA and combined with charged-tRNA. The numerator represents the uncharged-tRNA and if it increases, ppGpp concentration increases in proportion. The charged-tRNA, ‘C’ formation is modelled using a Michaelis-Menten term that increases with free amino acid concentration:

$$C = T \frac{A ( t )}{{K}_{a} + A ( t )} \qquad ( 9 )$$

Where, ‘A’ is the free amino acids concentration, Kₐ=20 μM is the dissociation constant for amino acids (20). ‘T’ is the total tRNA concentration, combining both charged and uncharged tRNAs.

T=U+C (10)

It has been proposed earlier that the molar ration between T and ribosome concentration is independent of growth rate (28), hence:

T=Cᵣ·rRNA(t) (11)

Where, Cᵣ=0.25.

Similarly, the translation of synthesized mRNAs is governed by the availability of free ribosomes. Free ribosomes form complexes with mRNAs binding at the ribosome binding site, and initiate peptide chain elongation by adding amino acids to the growing chain. The rate of change in concentration of free ribosomes is modelled by their consumption due to complex formation with native mRNAs, and formation from total ribosomes synthesized in the model using kinetic equations as given below,

$$\frac{d}{d r} fRib ( t ) = 0.2 ( \frac{d}{d t} rRNA ( t ) ) - \frac{d}{d t} {MR}_{p} ( t ) - \frac{d}{d t} {MR}_{rp} ( t ) \qquad ( 12 )$$

It has previously been postulated that the free ribosome pool is smaller than that of total ribosomes and proportional to the growth rate (29). Also, the rate of peptide elongation for individual ribosomes is constant regardless of growth rates. In slow growing conditions the level of free RNA polymerase is higher (30). Hence, the dynamic addition of free ribosomes was modelled as 20% of the synthesized ribosomes synthesized from the model.

$$\frac{d}{d t} {MR}_{p} ( t ) = {k}_{3}^{f} \cdot {fMR}_{p} ( t ) \cdot fRib ( t ) - ( {k}_{3}^{b} + {α}_{p} ) \cdot {MR}_{p} ( t ) \qquad ( 13 )$$

The rate of change of bulk native protein concentration is given by its synthesis rate minus the degradation.

$$\frac{d}{d t} Bp ( t ) = {α}_{p} \cdot {MR}_{p} ( t ) \cdot {A}_{R} - {β}_{p} \cdot Bp ( t ) \qquad ( 14 )$$

Where, ‘Bp’ is the concentration of native proteins, βₚ=0.15*10⁻³ s⁻¹ is the dilution rate of native proteins (7), MRₚ is the mRNA—ribosomes elongation complex, A_{R}=

$$[ \frac{\frac{C}{{K}_{C}}}{( 1 + \frac{U}{{K}_{U}} + \frac{C}{{K}_{C}} )} ] ,$$

represents the fraction of active translating ribosomes.

### Nutrient Influx and Monomer Synthesis

E. coli grows in minimal media with any carbon source for fuelling metabolic reactions to synthesize metabolites and triggering ATP synthesis through cellular respiration. The bacterial growth rate depends on the carbon source, in this case glucose. The glucose uptake in the present model is based on simple Michaelis-Menten kinetics. The rate of change in external glucose concentration (Glu) is equal to glucose consumed per unit time.

$$\frac{d}{d t} Glu ( t ) = - {β}_{glu} \cdot \frac{Glu ( t )}{Glu ( t ) + {K}_{M}} \qquad ( 15 )$$

Where, β_{glu}=1.7*10⁻⁵ g/h cm², is the maximum rate of glucose uptake by a single cell (31). K_{M}=1.75 μM is the apparent saturation constant (31, 32). We assumed that a single cell has a maximum rate of uptake of glucose, providing the driving force for growth. The second assumption is that the external glucose concentration decreases with decreasing growth rates. In E. coli, glucose uptake capacity remains constant over range of growth rates and uptake rates are limited by external glucose availability (33).

Next, the amount of glucose consumed needs to get converted to ATP molecules. The rate of ATP formation follows an uncompetitive hill kinetics from glucose concentration (Glu). The rate of change of ATP concentration is given by its formation taking glucose as substrate, minus its consumption by monomer (amino acid and nucleotide) synthesis, and minus its degradation.

$$\frac{d}{d t} ATP ( t ) = \frac{{V}_{S} \cdot Glu ( t ) \cdot {K}_{3}^{n}}{{K}_{S} \cdot {K}_{3}^{n} + Glu ( t ) ( {K}_{3}^{n} + {ATP ( t )}^{n} )} - \frac{d}{d t} A ( t ) - \frac{d}{d t} N ( t ) - {β}_{ATP} \cdot ATP ( t ) \qquad ( 16 )$$

Where, Vₛ=15 mM min⁻¹ and Kₛ, =3*10⁻³ M were defined as the kinetic parameters for the conversion of glucose to ATP, since the metabolic flux in terms of the concentration of ATP (20, 34). K₃=10⁻⁴ M is the apparent dissociation constant for the feedback inhibition by ATP (35). f₄=0.01 is the mole fraction of the amino acid in protein and f_{N}=1 is the mole fraction of the nucleotide in RNAs (20). n=2, is the hill coefficient. βₐₜₚ=0.035 s⁻¹, is the rate of ATP breakdown (31).

Similarly, we modelled the rate of free amino acid (A) and nucleotide (N) pools, needed for protein and RNA synthesis. The ATP generated is used as a substrate for the monomer synthesis. ATP fuels enzymatic reactions for metabolite synthesis and for deriving monomers from these metabolites (36). However, the concentration of ATPs and other nucleotides is a weak function of growth rate. The likely connection between metabolic reactions and macromolecule synthesis is given by the concentrations of metabolites and monomers synthesised from those metabolites (20). The controlling monomers are suggested to be amino acids that are sensed and controlled by regulatory compounds to control the macromolecular synthesis (37).

The rate of change of free nucleotide concentration is given by nucleotide formation, using ATP as substrate, minus its consumption for RNA and DNA synthesis.

$$\frac{d}{d t} N ( t ) = \frac{{V}_{S} \cdot \frac{2 \cdot ATP ( t )}{5} \cdot {K}_{2}^{n}}{( {K}_{S} + \frac{2 \cdot ATP ( t )}{5} ) ( {K}_{2}^{n} + {N ( t )}^{n} )} - {f}_{N} \cdot ( \frac{d}{d t} M ( t ) + \frac{d}{d t} {M}_{rp} ( t ) + \frac{d}{d t} rRNA ( t ) + \frac{d}{d t} DNA ( t ) ) - {β}_{n} \cdot N ( t ) \qquad ( 17 )$$

Where, Vₛ=10 μM s⁻¹ and Kₛ=4*10⁻⁴ M, are the kinetic parameters for the conversion of ATP to nucleotides. K₂=10 μM, is the dissociation constant for the feedback inhibition by nucleotides, βₙ=0.03 h⁻¹ is the rate of nucleotide breakdown (31). The assumption here is 2/5 of ATP synthesized is used for the synthesis of nucleotides.

Similarly, the rate of change of free amino acids is modelled by its formation using ATP as substrate, minus its consumption for protein synthesis.

$$\frac{d}{d t} A ( t ) = \frac{{V}_{S} \cdot \frac{ATP ( t )}{5} \cdot {K}_{1}^{n}}{( {K}_{S} + \frac{ATP ( t )}{5} ) ( {K}_{1}^{n} + {A ( t )}^{n} )} - {f}_{A} \cdot ( \frac{d}{d t} Bp ( t ) + \frac{d}{d t} RNAP ( t ) ) - {β}_{a} \cdot A ( t ) \qquad ( 18 )$$

Where, Vₛ=25 μM s⁻¹ and Kₛ, =5*10⁻⁴ M, are the kinetic parameters for the conversion of ATP to amino acids (20). K₁=10 μM, is the dissociation constant for the feedback inhibition by amino acids. βₐ=0.025 h⁻¹, is the rate of amino acids breakdown (31). In the case of amino acids the assumption is that 1/5 of ATP levels are used for amino acid synthesis. The overall balance of 2/5 ATP levels (i.e., that not used for monomer synthesis) is used for the fuelling of other major reactions such as lipid formation etc.

### RNA Polymerase Synthesis

The rate of transcription in the cell depends upon the concentration of RNA polymerase (19, 24). We modelled the synthesis of RNA polymerase for the dynamic supply of free RNA polymerase for the purposes of RNA synthesis. RNA polymerase synthesis is modelled by the formation of RNA polymerase mRNA using free RNA polymerase, followed by the synthesis of RNA polymerases by translation of those mRNAs by free ribosomes. It was assumed that 1% of the total promoter concentration is made up of genes responsible for RNA polymerase mRNA generation.

$$\begin{matrix}\frac{d}{d t} {PC}_{mr} ( t ) = {k}_{1}^{f} \cdot 0.01 \cdot {fP}_{m} ( t ) \cdot fRa ( t ) - ( {k}_{2}^{b} + {α}_{m} ) \cdot {PC}_{mr} ( t ) & ( 19 ) \\ \frac{d}{d t} {MR}_{rp} ( t ) = {k}_{4}^{f} \cdot {fMR}_{rp} ( t ) \cdot fRib ( t ) + ( {k}_{4}^{b} + {α}_{p} ) \cdot {MR}_{rp} ( t ) & ( 20 )\end{matrix}$$

The rate of change of RNA polymerase mRNA generation is based on the elongation rate of transcription complex minus the degradation rate, which is given as:

$$\frac{d}{d t} {M}_{rp} ( t ) = {α}_{m} \cdot {PC}_{mr} ( t ) \cdot {A}_{rp} - {β}_{m} \cdot {M}_{rp} ( t ) \qquad ( 21 )$$

Similarly, the rate of change of RNA polymerase synthesis is given as the elongation rate of mRNA-ribosome complex minus the dilution rate as given by:

$$\frac{d}{d t} RNAP ( t ) = {α}_{p} \cdot {MR}_{rp} ( t ) \cdot {A}_{R} - {β}_{p} \cdot R ( t ) \qquad ( 22 )$$

The concentration of RNA polymerase increases with growth rate and this complement in the cell is partitioned into active (transcribing) RNAs, accounting for about 17% to 30% of the complement at any instant, and inactive (non-specifically bound, free and assembly intermediates) RNAs (19, 24).

### DNA Synthesis

The cell cycle of E. coli has a period for replication initiation ‘B’, a DNA synthesis period ‘C’, and a period after completion of DNA replication and just before the start of cell division. Under minimal medium conditions, the doubling time is the time required to replicate bacterial DNA. In E. coli, DNA replication is regulated tightly in order to co-ordinate with growth and is responsive to nutrient availability (38). Initiation of DNA replication is inhibited during amino acid starvation signalled by ppGpp synthesis (39). In a recent study, it was concluded that ppGpp majorly regulates replication elongation rates exerting tuneable control over replication elongation in response to starvation conditions in order to preserve the genome integrity (40). The major assumption in our model is that the initiation of DNA replication at the chromosomal origin oriC occurs before the simulation starts and it is also not inhibited during stringent response, since we are only looking into a single cell that needs to double in order to study the composition of the cell and its growth effects. Also the model assumes that after the completion of chromosome replication (or DNA synthesis), the cell divides and doubles indicating the doubling time to predict the growth rate of the cell. The DNA concentration is not growth limiting (24) and it was assumed to be constant in a single cell.

The rate of change of DNA concentration is given by the rate of synthesis of DNA by elongation through addition of nucleotides, controlled by the regulator compound ppGpp accumulation.

$$\frac{d}{d t} DNA ( t ) = r \cdot {α}_{d} \cdot [ DNA ] \cdot {A}_{dp} \qquad ( 23 )$$

Where, α_{d}=1/1250 s⁻¹ to replicate a single strand of chromosome, and

$${A}_{dp} = \frac{( \frac{N ( t )}{{K}_{N} + N ( t )} )}{( 1 + \frac{N ( t )}{{K}_{N} + N ( t )} )}$$

represents actively replicating DNA polymerases. The concentration of DNA is assumed to be constant which is equal to 4 nM (41). The model captures the time it takes for the concentration of DNA to saturate at 4 nM and that doubling time (t_{d}) is used to calculate the specific growth rate of the cell (doublings/hr) using the following formula, Specific growth rate,

$$μ = \frac{In 2}{{t}_{d}} \qquad ( 24 )$$

The doubling time calculated from the model, is fed again into the system to determine the concentrations of all the growth-dependent parameters like free RNA polymerase, ribosomes, ppGpp, amino acids, nucleotides, ATPs, mRNA and proteins.

### Transcription and Translation Inhibition

In this section, we provide the dynamics of transcription and translation inhibition using our virtual cell model. Since, the virtual cell model uses both free RNA polymerases and ribosomes for transcription and translation processes. The assumption here is the transcription and translation inhibitors competitively bind only to the free enzymes, blocking the promoter and mRNA binding correspondingly. The transcription inhibitor rifampicin that inhibits the E. coli RNA polymerase is shown to productively prevent initiation of RNA synthesis but not the elongation of RNA chains (42). Similarly, the tetracycline (translation inhibitor) binds to the 30S subunit of ribosomes preventing the binding of charged tRNA at the A-site (43). The association of free RNA polymerase with the inhibitor (rifampicin) is modelled as,

$$\frac{d}{d t} RaI ( t ) = {k}_{a} \cdot fRa ( t ) \cdot {[ I ]}^{n} - {k}_{b} \cdot RaI ( t ) \qquad ( 25 )$$

Where, kₐ=10⁶ M⁻¹ s⁻¹ (44) & k_{b}=M are the forward and backward rate constants for the inhibitor (rifampicin) binding, I is the inhibitor concentration & n=2 is the binding cooperativity.

The dynamics of free RNA polymerase becomes,

$$\frac{d}{d t} fRa ( t ) = 0.2 ( \frac{d}{d t} RNAP ( t ) ) - \frac{d}{d t} {PC}_{m} ( t ) - \frac{d}{d t} {PC}_{r} ( t ) - \frac{d}{d t} {PC}_{mr} ( t ) - \frac{d}{d t} RaI ( t ) \qquad ( 26 )$$

Similarly, the association of free ribosomes with the inhibitor (tetracycline) is modelled as,

$$\frac{d}{d t} RibI ( t ) = {k}_{c} \cdot fRib ( t ) \cdot {[ I ]}^{n} - {k}_{d} \cdot RibI ( t ) \qquad ( 27 )$$

Where, k=10⁶ M⁻¹ s⁻¹ (45) & k_{d}=10⁻³ M are the forward and backward rate constants for the inhibitor (tetracycline) binding, I is the inhibitor concentration & n=2 is the binding cooperativity.

The dynamics of free ribosomes becomes,

$$\frac{d}{d t} fRib ( t ) = 0.2 ( \frac{d}{d t} rRNA ( t ) ) - \frac{d}{d t} {MR}_{p} ( t ) - \frac{d}{d t} {MR}_{rp} ( t ) - \frac{d}{d t} RibI ( t ) \qquad ( 28 )$$

The reduction in free RNA polymerases reduces the RNA synthesis and eventually protein synthesis also gets impacted due to lower levels of rRNA synthesis. In the case of translation inhibition, the reduced amount of free ribosomes, reduces the levels of rRNA and amount of bulk proteins. Also, the immediate reduction in the bulk protein levels implies a discrete reduction in the rates of fuelling reactions changing the concentrations of amino acids and nucleotides synthesis which distinctly changes the level of ATP synthesis. The immediate shift down in the rates of synthesis of amino acids and nucleotides due to the inhibition is modelled as,

$$\frac{d}{d t} A ( t ) = \frac{{V}_{S} \cdot \frac{ATP ( t )}{5} \cdot {K}_{1}^{n}}{( {K}_{S} + \frac{ATP ( t )}{5} ) \cdot ( 1 + \frac{[ I ]}{{K}_{I}} ) ( {K}_{1}^{n} + {A ( t )}^{n} )} - {f}_{A} \cdot ( \frac{d}{d t} Bp ( t ) + \frac{d}{d t} RNAP ( t ) ) - {β}_{a} \cdot A ( t ) \qquad ( 29 )$$

Where, K_{I} represents the inhibitory potency. The inhibitory potency for rifampicin & tetracycline used in our simulations are K_{I}=10⁻⁹M (44) & K₁=10⁻⁶M (45) respectively. The concentration of transcription inhibitor (rifampicin) used are 10 μM, 8 μM & 6 μM and the translation inhibitor (tetracycline) used are 4 μM, 2 μM & 1 μM.

$$\frac{d}{d t} N ( t ) = \frac{{V}_{S} \cdot \frac{2 ATP ( t )}{5} \cdot {K}_{2}^{n}}{( {K}_{S} + \frac{2 ATP ( t )}{5} ) \cdot ( 1 + \frac{[ I ]}{{K}_{I}} ) ( {K}_{2}^{n} + {N ( t )}^{n} )} - {f}_{N} \cdot ( \frac{d}{d t} M ( t ) + \frac{d}{d t} {M}_{rp} ( t ) + \frac{d}{d t} rRNA ( t ) + \frac{d}{d t} DNA ( t ) ) - {β}_{n} \cdot N ( t ) \qquad ( 30 )$$

The inhibitor concentrations mentioned were varied accordingly and the overall impact on the cellular composition of the cell and its growth rate are calculated accordingly from the time the DNA synthesis gets saturated at the specified amount.

### Heterologous Gene Expression

Once, the native system has been modelled and evaluated. We incorporated heterologous systems into the model to evaluate the growth effects and composition of the cell. The mathematical model describes from a transformed plasmid inside the host. In this study we investigated simple constitutive and inducible devices. For both the devices, the mRNA and proteins generation of the synthetic circuit is similar to the host. The free RNA polymerase binds to free plasmid forming an activated complex initiating transcription and mRNA generation.

$$\begin{matrix}\frac{d}{d t} {PC}_{fm} ( t ) = {k}_{a}^{f} \cdot {fP}_{fm} ( t ) \cdot fRa ( t ) - ( {k}_{a}^{b} + {α}_{mf} ) \cdot {PC}_{fm} ( t ) & ( 31 ) \\ \frac{d}{d t} {M}_{fp} ( t ) = {α}_{fm} \cdot {PC}_{fm} ( t ) \cdot {A}_{rp} - {β}_{m} \cdot {M}_{fp} ( t ) & ( 32 )\end{matrix}$$

Where, k^{f}ₐ & k^{b}ₐ are the forward and reverse rate constants for the free RNA polymerase binding to the free foreign promoter. fP_{fm}=(Total plasmid concentration—PC_{fm}). Similarly, the free ribosomes synthesized binds to free foreign mRNA forming an activated complex initiating translation and synthesizing foreign proteins.

$$\begin{matrix}\frac{d}{d t} {MR}_{fp} ( t ) = {k}_{b}^{f} \cdot {fM}_{fp} ( t ) \cdot fRib ( t ) - ( {k}_{b}^{b} + {α}_{fp} ) \cdot {M}_{fp} ( t ) & ( 33 ) \\ \frac{d}{d t} Fp ( t ) = {α}_{fp} \cdot {M}_{fp} ( t ) \cdot {A}_{R} - {β}_{p} \cdot Fp ( t ) & ( 34 )\end{matrix}$$

Where, k^{f}_{b} & k^{b}_{b} are the forward and reverse rate constants for the free ribosomes binding to the free foreign mRNA.

The consumption of the free RNA polymerases, nucleotides, free ribosomes and amino acids for the generation of foreign mRNA and proteins are updated in the host cell model equations. In the case of constitutive expression, we studied three promoters with different strengths (High, medium and low). We experimentally constructed the circuits and derived the relative promoter units for the studied promoters. Using the RPUs, we calculated the transcription rates of the devices based on the reference promoter (rrnB), shown in Table 1B.

TABLE 1B
Parameters used for the simulation of the constitutive devices.

| Constitutive | Relative | | | | mRNA | Protein |
|---|---|---|---|---|---|---|
| Promoters | promoter | Transcription | Translation | Plasmid | expression | expression |
| used in this | unit | rate (relative) | rate (relative) | concentration | (Km)^{m} | (Km)^{p} |
| study | (RPU) | (s⁻¹) | (46) (mRNA⁻¹ s⁻¹) | (47) (μM) | (μM) | (μM) |
| J23105 | 0.3 | 0.55 | 0.4 | 0.1 | 1.3 | 0.41 |
| rrnB (19) | 1 | 1.83 | 0.4 | 0.1 | 4.4 | 0.41 |
| P67 | 1.3 | 2.4 | 0.4 | 0.1 | 3.6 | 0.41 |

Our inducible circuit has two parts, one constitutively ON promoter synthesizing the LasR transcription factor which binds to the externally added inducer forming a complex which activates the downstream synthesis of the reporter protein, RFP. The constitutive promoter activity producing the LasR is modelled using the above equations. Next, the inducer and LasR binding is modelled by,

$$\frac{d}{d t} IFp ( t ) = {k}_{f} \cdot ( Fp ( t ) - IFp ( t ) - PIFp ( t ) ) \cdot {[ AHL ]}^{n} - {k}_{b} \cdot IFp ( t ) \qquad ( 35 )$$

Where, k_{f}=106 M⁻¹ s⁻¹ & k_{b}=10⁻³ M are the forward and reverse rate constants for the inducer and LasR binding. The conservation equation for the free LasR is the total (Fp) minus the inducer-LasR complex (IFp) minus the promoter bound inducer-LasR complex (PIFp). AHL concentrations used in this study are 10⁻⁷-10⁻⁹M. n=2, is the inducer binding cooperativity.

The rate of change of promoter bound inducer-LasR complex (PIFp) is given as,

$$\frac{d}{d t} PIFp ( t ) = {k}_{f 1} \cdot IFp ( t ) \cdot fPIFp ( t ) - {k}_{b 1} \cdot PIFp ( t ) \qquad ( 36 )$$

Where, k_{f1}=10⁸ M⁻¹ s⁻¹ & k_{b1}=0.1 M are the forward and reverse rate constants for the inducer-LasR complex and promoter binding for downstream reporter gene synthesis. The synthesis of the reporter protein is modelled similar to the above foreign protein synthesis equations (31-34). The simulations were run along with the foreign circuit's equations implemented in the host to determine the growth rate and other parameters as described above.

### Toggle Switch

The toggle switch is constructed from two repressible promoters (in this case: X & Y) in a mutually repressible arrangement (FIG. 27). As established earlier (16), the toggle switch was modelled accordingly: (i) bistability of the toggle system depends on the cooperativity index, (ii) synthesis rates of both the repressors needs to be balanced & (iii) initial condition of any of the repressor above the separatrix. The repressors (X & Y) mRNA and protein generation are modelled using the following equations:

$$\begin{matrix}\frac{d}{d t} {X}_{mRNA} = \frac{{α}_{mf} ( {PC}_{m 1} ) {A}_{rp}}{1 + {( \frac{[ Y ]}{K ( 1 + {( \frac{[ {I}_{A} ]}{{K}_{I}} )}^{m} )} )}^{n}} - {β}_{m} {X}_{mRNA} & ( 37 ) \\ \frac{d}{d t} X = {α}_{fp} \cdot {RX}_{mRNA} \cdot {A}_{R} - {β}_{p} \cdot X & ( 38 ) \\ \frac{d}{d t} {Y}_{mRNA} = \frac{{α}_{mf} ( {PC}_{m 2} ) {A}_{rp}}{1 + {( \frac{[ X ]}{K ( 1 + {( \frac{[ {I}_{B} ]}{{K}_{I}} )}^{m} )} )}^{n}} - {β}_{m} {Y}_{mRNA} & ( 39 ) \\ \frac{d}{d t} Y = {α}_{fp} \cdot {RY}_{mRNA} \cdot {A}_{R} - {β}_{p} \cdot Y & ( 40 )\end{matrix}$$

Where, X_{mRNA} & Y_{mRNA} are the respective mRNA concentrations of the repressors, X is the concentration of repressor 1, Y is the concentration of repressor 2, PCₘ₁ & PCₘ₂ are the transcription initiation complexes, α_{mf} is the transcription rates of the repressors, is the mRNA degradation rate, RX_{mRNA} & RV_{mRNA} are the translation initiation complexes, α_{fp} is the translation rates of the repressors, βₚ is the protein degradation rate, n is the cooperativity of repression of the repressors, K is the dissociation constant of the repressors, K₁ is the dissociation constant of the inducer (IPTG), I_{A} & I_{B} are the inducer concentrations and m is the cooperativity of IPTG binding. The model parameters for the theoretical analysis are X(0)=2×10⁻⁵ M, Y (0)=0, α_{mf}=2.4 s⁻¹, βₘ=0.0083 s⁻¹, α_{fp}=0.4 mRNA⁻¹ s⁻¹, βₚ=0.0017 s⁻¹, K=4×10⁻⁵ M, m=2 & K_{I}=3×10⁻⁵M.

Using the model, we varied the external glucose levels (20 & 0.1 mM) and cooperativity of repression (n=2-4) simultaneously to simulate the growth effects and behaviour of the toggle switch system. For this, the above parameters were maintained except the inducer levels (I_{A}=0 & I_{B}=0.01-10⁻⁶ M) were varied. Finally, we studied both the growth effects and the bistability under varying transcription rates (0.05-3 s⁻¹) of both the repressors with (I_{B}=10⁻³ M) and without inducer. The external glucose levels tested were 20 mM and 0.1 mM.

### Repressilator

A ring oscillator (FIG. 28), in which the first repressor protein (X) represses the synthesis of second repressor protein (Y), which in turn represses the synthesis of third repressor protein (Z). Finally, the third repressor protein (Z) represses the synthesis of the first repressor (X). Similar to the original publication, we maintained identical transcription and translation rates for the synthesis of respective mRNAs and repressor proteins (17). The repressors (X, Y & Z) mRNA and protein generations are modelled using the following equations.

$$\begin{matrix}\frac{d}{d t} {X}_{mRNA} = \frac{{α}_{mf} ( {PC}_{m 1} ) {A}_{rp}}{1 + {( \frac{[ Z ]}{K} )}^{n}} - {β}_{m} {X}_{mRNA} & ( 41 ) \\ \frac{d}{d t} X = {α}_{fp} \cdot {RX}_{mRNA} \cdot {A}_{R} - {β}_{p} \cdot X & ( 42 ) \\ \frac{d}{d t} {Y}_{mRNA} = \frac{{α}_{mf} ( {PC}_{m 2} ) {A}_{rp}}{1 + {( \frac{[ X ]}{K} )}^{n}} - {β}_{m} {Y}_{mRNA} & ( 43 ) \\ \frac{d}{d t} Y = {α}_{fp} \cdot {RY}_{mRNA} \cdot {A}_{R} - {β}_{p} \cdot Y & ( 44 ) \\ \frac{d}{d t} {Z}_{mRNA} = \frac{{α}_{mf} ( {PC}_{m 3} ) {A}_{rp}}{1 + {( \frac{[ Y ]}{K} )}^{n}} - {β}_{m} {Z}_{mRNA} & ( 45 ) \\ \frac{d}{d t} Z = {α}_{fp} \cdot {RZ}_{mRNA} \cdot {A}_{R} - {β}_{p} \cdot Z & ( 46 )\end{matrix}$$

Where, X_{mRNA}, Y_{mRNA} & Z_{mRNA} are the respective mRNA concentrations of the repressors, X is the concentration of repressor 1, Y is the concentration of repressor 2, Z is the concentration of repressor 3, PCₘ₁, PCₘ₂ & PCₘ₃ are the transcription initiation complexes, α_{mf} is the transcription rates of the repressors, βₘ is the mRNA degradation rate, RX_{mRNA}, RY_{mRNA} & RZ_{mRNA} are the translation initiation complexes, α_{fp} is the translation rates of the repressors, βₚ is the protein degradation rate, n is the cooperativity of repression of the repressors, K is the dissociation constant of the repressors. The model parameters for the theoretical analysis are X (0)=2×10⁻⁵ M, Y (0)=0, Z (0)=0, α_{mf}=2.4 s⁻¹, βₘ=0.0083 s⁻¹, α_{fp}=0.4 mRNA⁻¹ s⁻¹, βₚ=0.0017 s⁻¹ & K=4×10⁻⁵ M.

Similar to the toggle switch, we varied the external glucose levels (20-0.001 mM) and coefficient of repression (n=2-4) with the repressilator in the model to study the growth effects and repressilator behaviour. Each of the simulations was run for only one generation. Finally, we studied the growth rate and period of oscillations of the repressilator by varying the degradation rates of both repressor mRNAs (0.05-10⁻⁵ s⁻¹) and proteins (0.05-10⁻⁵ s⁻¹). We simulated the system with fixed external glucose levels at two different concentrations (20 & 0.1 mM), cooperativity of repression was maintained at n=2.

TABLE 2
List of initial conditions used in our model.

| S. no | Symbols | Model variables | Initial values | Reference |
|---|---|---|---|---|
| 1. | fRa(t) | Free RNA | 2.1 * 10⁻⁶M | (18) |
| | | polymerase | | |
| 2. | PCₘ(t) | RNA polymerase- | 0 | |
| | | Promoter | | |
| | | complex mRNA | | |
| | | genes | | |
| 3. | fPₘ(t) | Free promoter | 0 | |
| | | mRNA genes | | |
| 4. | Pₘ = PCₘ + fPₘ | Total promoter | 2.09 * 10⁻⁶M | (19) |
| | | mRNA genes | | |
| 5. | M(t) | Native mRNA | 0 | |
| 6. | Mᵣₚ(t) | RNA polymerase | 0 | |
| | | mRNA | | |
| 7. | N(t) | Nucleotide | 0 | |
| 8. | PCᵣ(t) | RNA polymerase- | 0 | |
| | | Promoter | | |
| | | complex rRNA | | |
| | | genes | | |
| 9. | fPᵣ(t) | Free promoter | 0 | |
| | | rRNA genes | | |
| 10. | Pᵣ = PCᵣ + fPᵣ | Total promoter | 0.04 * 10⁻⁶M | (19) |
| | | rRNA genes | | |
| 11. | PCₘᵣ(t) | RNA polymerase- | 0 | |
| | | Promoter | | |
| | | complex RNA | | |
| | | polymerase genes | | |
| 12. | rRNA(t) | Ribosomes | 0 | |
| 13. | MRₚ(t) | Ribosome- | 0 | |
| | | mRNA complex | | |
| 14. | MRᵣₚ(t) | Ribosome-RNA | 0 | |
| | | polymerase | | |
| | | mRNA complex | | |
| 15. | fMRₚ(t) | Free mRNA | 0 | |
| 16. | fRib(t) | Free ribosomes | 4.1 · 10⁻⁶M | (18) |
| 17. | Rₚ = MRₚ + | Total native | 0 | |
| | fMRₚ(t) | mRNAs | | |
| 18. | Bp(t) | Total native | 0 | |
| | | proteins | | |
| 19. | RNAP(t) | RNA polymerase | 0 | |
| 20. | G(t) | ppGpp | 0 | |
| 21. | A(t) | Amino acids | 0 | |
| 22. | ATP(t) | ATP | 0 | |
| 23. | Glu(t) | External glucose | 0.02-0.0001M | Minimal |
| | | concentration | | media |
| 24. | DNA(t) | DNA synthesis | 0 | |

TABLE 3
List of parameters used in our model.

| | | Model | | |
|---|---|---|---|---|
| S. no | Symbols | parameters | Reference values | References |
| 1. | k^{f}₁ (M⁻¹ s⁻¹) | Forward rate | 10⁶ | (19) |
| | | constant | | |
| | | (holoenzyme- | | |
| | | mRNA | | |
| | | promoter | | |
| | | complex) | | |
| 2. | k^{b}₁ (s⁻¹) | Backward rate | 0.65 | (19) |
| | | constant | | |
| 3. | αₘ (s⁻¹) | Maximum | 0.05 | (19, 48) |
| | | rate of mRNA | | |
| | | transcription | | |
| 4. | βₘ (s⁻¹) | mRNA | 0.0029 | (7) |
| | | degradation | | |
| | | rate | | |
| 5. | K_{N} (M) | Nucleotide | 0.02 * 10⁻⁴ | (49) |
| | | dissociation | | |
| | | constant | | |
| 6. | k^{f}₂ (M⁻¹ s⁻¹) | Forward rate | 10⁶ | (19) |
| | | constant | | |
| | | (holoenzyme- | | |
| | | rRNA | | |
| | | promoter | | |
| | | complex) | | |
| 7. | k^{b}₂ (s⁻¹) | Backward rate | 0.01 | (23) |
| | | constant | | |
| 8. | αᵣ (s⁻¹) | Maximum | 1.83 | (19, 20, 48) |
| | | rate of rRNA | | |
| | | transcription | | |
| 9. | K_{g} (μM) | Dissociation | 40 | (20) |
| | | constant for | | |
| | | ppGpp | | |
| 10. | h | Cooperativity | 2 | (20) |
| | | of ppGpp | | |
| | | binding | | |
| 11. | βᵣ (s⁻¹) | rRNA | 0.00015 | (7) |
| | | degradation | | |
| | | rate | | |
| 12. | k^{f}₃, k^{f}₄ (M⁻¹ | Forward rate | 10⁶ | (23) |
| | s⁻¹) | constant | | |
| | | (ribosomes- | | |
| | | mRNA | | |
| | | complex) | | |
| 13. | k^{b}₃, k^{b}₄ (s⁻¹) | Backward rate | 0.01 | (23) |
| | | constant | | |
| 14. | αₚ (mRNA⁻¹ | Maximum | 0.07 | (48) |
| | s⁻¹) | rate of mRNA | | |
| | | translation | | |
| 15. | K_{C} (μM) | Dissociation | 2.75 | (20) |
| | | constant for | | |
| | | aminoacyl | | |
| | | tRNA | | |
| 16. | K_{U} (μM) | Dissociation | 10 | (20) |
| | | constant for | | |
| | | uncharged | | |
| | | tRNA | | |
| 17. | βₚ (s⁻¹) | Protein | 0.00015 | (7) |
| | | degradation | | |
| | | rate | | |
| 18. | k₁ (s⁻¹) | Maximum | 1 | (20) |
| | | rate of ppGpp | | |
| | | formation | | |
| 19. | k₂ (s⁻¹) | Rate constant | 0.035 | (20) |
| | | for ppGpp | | |
| | | breakdown | | |
| 20. | V_{S} (μM⁻¹ s⁻¹) | Kinetic | 25 | (20) |
| | | parameter for | | |
| | | conversion of | | |
| | | precursor to | | |
| | | AA's | | |
| 21. | V_{S} (μM⁻¹ s⁻¹) | Kinetic | 10 | (31) |
| | | parameter for | | |
| | | conversion of | | |
| | | precursor to | | |
| | | N's | | |
| 22. | V_{S} (mM⁻¹ | Kinetic | 0.25 | (31, 50) |
| | min⁻¹) | parameter for | | |
| | | conversion of | | |
| | | precursor to | | |
| | | ATP's | | |
| 23. | K₁ (μM) | dissociation | 10 | (20) |
| | | constant for | | |
| | | feedback | | |
| | | inhibition by | | |
| | | the AA | | |
| 24. | K₂ (μM) | dissociation | 10 | (35) |
| | | constant for | | |
| | | feedback | | |
| | | inhibition by | | |
| | | the N | | |
| 25. | n | Cooperativity | 2 | (20) |
| | | index | | |
| 26. | K_{S} (μM) | Kinetic | 500 | (20) |
| | | parameter for | | |
| | | conversion of | | |
| | | precursor to | | |
| | | AA's | | |
| 27. | K_{S} (μM) | Kinetic | 400 | (34) |
| | | parameter for | | |
| | | conversion of | | |
| | | precursor to | | |
| | | N's | | |
| 28. | K_{S} (mM) | Kinetic | 3 | (20, 34, 50) |
| | | parameter for | | |
| | | conversion of | | |
| | | precursor to | | |
| | | ATP's | | |
| 29. | f_{A} | Mole fraction | 0.01 | (20) |
| | | of the amino | | |
| | | acid in protein | | |
| 30. | f_{N} | Mole fraction | 1 | (49) |
| | | of the | | |
| | | nucleotide in | | |
| | | RNA's | | |
| 31. | K₃ (μM) | dissociation | 100 | (35) |
| | | constant for | | |
| | | feedback | | |
| | | inhibition by | | |
| | | the ATP | | |
| 32. | βₐ (hr⁻¹) | Rate constant | 0.025 | (31) |
| | | for amino acid | | |
| | | breakdown | | |
| 33. | βₙ (hr⁻¹) | Rate constant | 0.03 | (31) |
| | | for nucleotide | | |
| | | breakdown | | |
| 34. | β_{ATP} (s⁻¹) | Rate constant | 0.035 | (31, 50) |
| | | for ATP | | |
| | | breakdown | | |
| 35. | β_{glu} (g/h | Glucose | 1.7 * 10−5 | (31) |
| | cm²) | uptake rate | | |
| 36. | K_{M} (g/h | Saturation | 1.75 * 10⁻⁵ | (32) |
| | cm²) | constant | | |
| 37. | α_{d} (s⁻¹) | Maximum | 1/1250 | (48) |
| | | rate of DNA | | |
| | | synthesis for a | | |
| | | single strand | | |

### Example

### Strains and Media

Escherichia coli Top10 (Invitrogen) strain was used for cloning and testing. Sequences of all BioBrick parts are available through the registry of Standard Biological Parts. The systems composed of Red fluorescence proteins (RFP) as the reporter protein under the control of the studied promoters were built using standard assembly techniques.

All our constructs were built on the vector pBbE8K (MEL USA), which is a high copy number plasmid with ColE1 replication origin (˜50-70 molecules per cell) and carries a kanamycin resistance marker. Characterization of constructs were carried out using supplemented minimal media (in 1 L) comprising: M9 salts (12.8 g Na₂HPO₄.7H₂O, 3 g KH₂PO₄, 0.5 g NaCl, 1 g NH₄Cl), 1M MgSO₄, 1M CaCl₂, 0.2% (w/v) casamino acids, 30 μg/ml kanamycin and glucose as the sole carbon source which was varied from 20 mM to 0.1 mM.

### Growth Conditions and Measurements

Seed cultures were grown in LB medium supplemented with 30 μg/ml kanamycin from freshly transformed plates and after 10 to 12 h of overnight growth, pre-cultures were inoculated in fresh LB medium at a dilution of 100× for 2 to 3 h exponential growth (OD₆₀₀=0.7−1). For characterization of the promoters in the vector pBbE8K, cell cultures were grown in 5 mL of pre-warmed LB medium at 37° C. in 50 mL test tubes, shaken at 225 rpm. The culture tubes were kept in ice for about 5 min to stop further growth and were pelleted by centrifugation for 2 min at 3300 g in 4° C., washed and diluted to OD₆₀₀=0.1 by resuspension in pre-warmed supplemented minimal media with different glucose concentrations ranging from 20 mM to 0.1 mM. Cultures were then transformed into transparent, flat-bottom 96-well plate in triplicate aliquots of 300 volume. The plate was incubated in 37° C. with shaking for 8 min and growth rates were monitored by measuring absorbance at 600 nm and fluorescence were monitored by measuring RFP at excitation 535 nm and emission 600 nm using Synergy HT microplate reader (Biotek) over time. Time series OD₆₀₀ and RFP data were collected for every 10 min for a total run time of 6 h.

For characterizations of inducible system (lasQS device) in the vector pBbE8K, cells were first grown to stationary phase overnight in LB medium before being diluted 100× into fresh LB medium. The diluted cells were grown to exponential phase (OD₆₀₀=1), washed and resuspended in supplemented minimal media with varying glucose concentration (20-0.1 mM) as mentioned earlier. Before being subjected to the microplate fluorescence assay, N-(3-Oxododecanoyl)-L-homoserine lactone (3-Oxo-C₁₂-HSL, Sigma-Aldrich) was added to the pre-culture (Top10—pTetR-LasR-pLuxR-RFP) at varying molar concentrations of 10⁻⁷-10⁻⁹ M. The cell cultures were measured for their OD₆₀₀ and RFP fluorescence for 6 h.

Similarly, for characterization of growth rates with transcription and translation inhibitors, varying concentrations of rifampicin (12 μM, 10 μM, 8 μM) and tetracycline (4 μM, 2 μM, 1 μM) were added to the wild-type (Top10—E8K) pre-culture. The cells were subjected to a microplate assay to measure their OD₆₀₀ for 6 h. Three biological replicates were used for all of the experiments conducted.

### Growth Rate and RFP Expression Analysis

For each promoter, the three OD₆₀₀ and RFP data were averaged and background absorbance (wells containing only media) and fluorescence (Top10—E8K)) were subtracted from the raw measurements to obtain OD₆₀₀ and RFP time series. Measurements were obtained in mid-exponential growth and growth rates were calculated as a time derivative of the OD curves, μ=d ln(OD)/dt. The activity of the promoters (RFP synthesis rate per cell) were calculated by, d(RFP)/dt/OD₆₀₀. Relative promoter units of every promoter studied were calculated by,

$$RPU = \frac{Promoter activity of larger protein}{Promoter activity of reference protein} .$$

The reference promoter used here is the native E. coli rrnB promoter, which has an RPU=1.

### Model for Virtual Cell

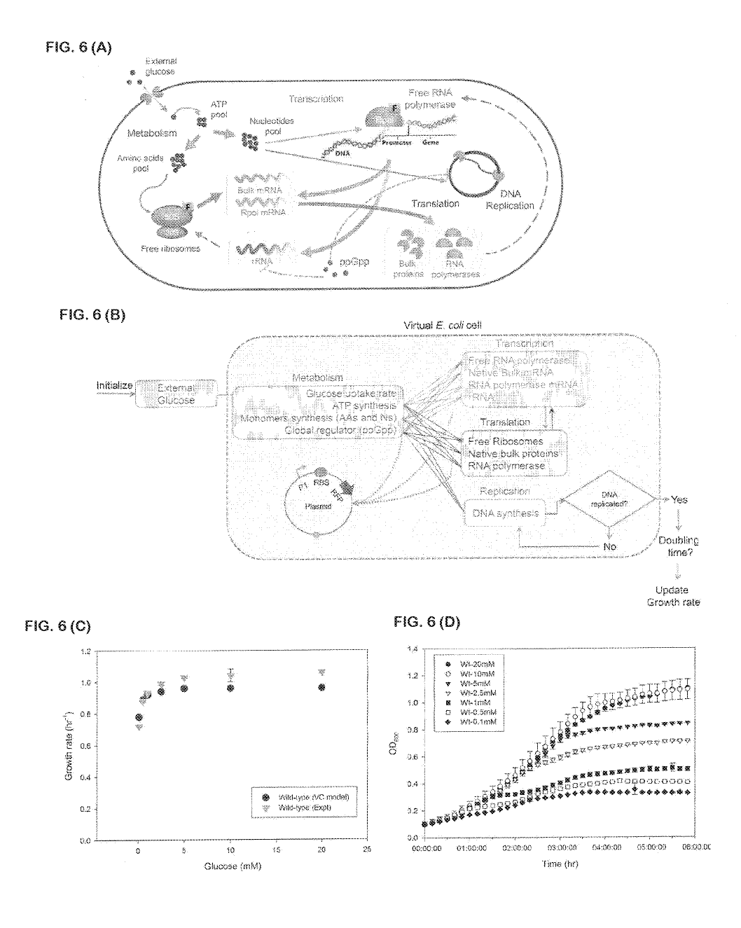

The virtual cell model is modelled into four individual modules that define key biological processes: metabolism, transcription, translation and replication and their interactions to determine the cellular composition and growth under exponential growth conditions (FIG. 6(A)). We designed this model with a certain level of abstraction to define the cellular processes accounting for bulk mRNA and protein synthesis, ribosomes, ppGpp (global regulator), ATP, amino acids, nucleotides and DNA synthesis. The model was designed to be able to study the effects of varying glucose concentrations, synthetic circuits or transcription/translation inhibition without undue computational expense. Each individual core module comprises ODEs with different sets of variables and parameters that are dependent on the rest of the core modules. The core modules, comprise different sub models which are structurally integrated by balancing their equations and linking their inputs and outputs. The model assumes glucose as the single carbon source. The simulations were run in loops with each of the module at the same time step that depends on the variables and parameters from other modules. The model based on ODEs was implemented in Maple15 and the ODEs were numerically integrated starting with a mixture of null and specific initial conditions. The initial conditions assumed were machineries such as free RNA polymerase with an initial concentration of 2.1 μM and free ribosomes=4.1 μM to build the E. coli virtual cell. Most of the model parameters used were based on originally reported experimental observations or values obtained through mathematical models from literatures. The model and the parameters used in the simulation were as described in more detail above.

FIG. 6(A) is a schematic representation of sub-models in a single virtual E. coli cell, grouped by metabolism (blue), transcription (green), translation (red) and DNA replication (purple). External glucose is up taken inside the virtual cell, which is converted into ATPs and those ATPs acts as substrates for the synthesis of monomers such as amino acids and nucleotides. The free RNA polymerases binds to the promoters and elongates by adding nucleotides to synthesize native bulk mRNAs, RNA polymerase mRNA and rRNA (green arrows). The free ribosomes binds to the mRNAs and synthesizes native bulk proteins and total RNA polymerases by adding the amino acids (red arrow). The total rRNA and RNA polymerases synthesized in the model feeds the free ribosomes and RNA polymerases availability (dotted grey arrow) dynamically for translation and transcription respectively. Simultaneously, nucleotides are added for the synthesis of DNA (purple arrow), which acts a timer in the model representing the doubling time. Importantly, in response to the availability of amino acids pool, the global regulator (ppGpp) is synthesized inside the model that controls the rate of rRNA and DNA synthesis.

FIG. 6(B) schematically depicts process flow and the interactions between variables inside each sub-model in FIG. 6(A) to predict the cellular growth rate. As the system is initialized, the external glucose is taken in by the metabolism sub-model to begin the virtual build of E. coli by bulk synthesizing key cellular components and macromolecules such as DNA, RNA and proteins. The system iterates until the DNA replication is complete, which updates the doubling time to calculate the growth rate of the cell and retrieve the cellular composition at that growth rate. The assumption here is the external glucose concentration controls, the growth rate of the cell. When, a heterologous system is expressed through plasmids inside the model, abduction of the cellular resources such as monomers (dotted blue arrow) and machineries such as free RNA polymerases (dotted green arrow) and ribosomes (dotted red arrow) levels are monitored to predict the impact on the host's growth rate. (C) Validation of the growth-rate prediction capacity of the virtual cell model under nutrient limiting conditions. The reduction in specific growth rate of wild-type E. coli Top10 (green inverted triangles) grown in M9 supplemented media with different concentrations of glucose (20 mM-0.1 mM) as a single carbon source. The dark red circles are model growth predictions, resulted in correlation coefficient |r|=0.985. (D) OD measurement (600 nm) for every 10 min under glucose limitation respectively.

### Model for Transcription and Translation Inhibition

The transcription and translation inhibition is modelled using enzyme-inhibition kinetics model. The model and the parameters used in the simulation were as described in more detail above. The transcription inhibitor (rifampicin) binds to the free RNA polymerase and translation inhibitor (tetracycline) binds to the free ribosomes reducing the transcription of wild-type bulk mRNA/proteins reducing the ATP synthesis leading to the growth inhibition. All the parameters used for the simulation are shown in Tables 2 and 3.

### Model for Synthetic Gene Circuits

The model for the synthetic gene circuits is similar to that of the host model transcription and translation. The model and the parameters used in the simulation were as described in more detail above. In brief, host machineries such as: free RNA polymerase and free ribosomes and resources such as nucleotides and amino acids are used for the synthesis of foreign mRNA and proteins (FIG. 6(B)). The synthetic circuits are integrated with the core modules to balance the consumption of the machineries and resources for synthesis. In this study we have used simple constitutive devices and a lasQS inducible device to study the growth effect under limiting nutrient conditions. The plasmid concentration was calculated according to the earlier studies (24, 47). The transcription rates of the constitutively ON promoters were derived based on the RPU calculated earlier. In the case of the inducible circuit model, a constitutively ON promoter produces LasR and the inducer (AHL) forms a complex with the LasR activating a downstream promoter to synthesize the reporter gene. Each step is formulated as ODE equations obtaining the inputs (free RNA polymerases/ribosomes, amino acids and nucleotides) from the host model and outputs (foreign mRNA and proteins). Each simulation was run in a loop to calculate the time the DNA concentration doubles, to derive the growth rate of the cell.

We tested our model by implementing two well-established benchmark circuits in order to evaluate their function inside the virtual cell. As a first benchmark, we chose the bistable toggle switch circuit (16), which consists of two repressible promoters arranged in a mutual inhibitory network and the toggle state can be flipped using an inducer. As another benchmark, we simulated the repressilator (17), where the first gene inhibits the transcription of the second gene, which inhibits the transcription of the third gene, which in turn represses the first gene. The performance of these circuits depends on factors such as co-operativity of repression of constitutively transcribed promoters, transcription, translation rates and degradation rates of the repressors mRNA and proteins. We varied the external glucose levels from 20-0.001 mM and co-operativity of repression (n=2-4), to study the growth effects of the toggle switch and switching threshold, maintaining identical transcription and translation rates for the repressors. Next, we varied the transcription rates to study the bistability of the toggle switch and growth profile of the virtual cell under two external glucose levels (20 mM and 0.1 mM) and with/without inducer concentration of 1 mM. For the repressilator, by varying the external glucose concentration (20 mM, 0.1 mM, 0.005 mM) and co-operativity of repression (n=2-4), the growth dynamics and range or periods (peak-to-peak) was studied by simulating the circuit with identical transcription/translation rates and mRNA/protein degradation rates. Furthermore, the degradation rates of the repressors were varied to determine the period of oscillations and growth profile at two external glucose concentrations (20 and 0.1 mM). The model and the parameters used in the simulation were as described in more detail above.

### Results

### Modelling and Construction of Virtual Cell

We developed an integrated virtual-cell model by dividing the total cellular processes of E. coli into four key modules namely, Metabolism, Transcription, Translation and Replication (FIG. 6(A)). The process flow of the model and the interactions of the modules are schematically represented in FIG. 6(B). The metabolism module 130 comprises variables such as glucose uptake rate, ATP synthesis, monomers such as amino acids and nucleotides synthesis and global regulator of E. coli, ppGpp formation. Since, the uptake of glucose by a cell represents the first step of metabolism that converts the carbon source into cellular components (32). The single virtual-cell model 116 takes the input of extracellular glucose concentration that is used for the formation of ATP and subsequently synthesizing the monomers such as amino acids and nucleotides. It has been proposed that the growth rate is not determined by the rate of ATP synthesis, and that the concentration of ATP and other nucleotides are also shown to minimal effect on the growth rate (20). The bulk RNAs (mRNA & rRNA) and protein synthesizing systems in the model are placed under the transcription 134 and translation 136 modules respectively. Free functional RNA polymerases engage in complex formation with the promoters transcribing mRNA and rRNA by drawing nucleotides from the monomer pool. Similarly, free functional ribosomes engage in complexes with the mRNAs forming bulk proteins and RNA polymerases by drawing amino acids from the resource pool synthesized from the metabolism module 130. The RNA polymerases and rRNA synthesized in the model constantly supply the free RNA polymerases and free ribosomes for the synthesis of bulk mRNAs and proteins. The global regulator 132, ppGpp is formed when the ribosomal activity is submaximal or when the A-site of the ribosome is bound by uncharged-tRNAs during stringent response (20). The ppGpp acts by regulating both rRNA synthesis and DNA elongation during replication (40, 51). Earlier studies have tried to model the regulation of rRNA expression based on two hypothesis like, ppGpp and availability of NTPs control the activity of rrn promoters and secondly, overall activity of these factors is based on the availability of amino acids against the consumption imposed by translating ribosomes (20, 21). The current model invokes this regulatory system combining both the hypotheses to study the overall effect on the growth and its cellular components. The DNA synthesis in the replication module 138 draws nucleotides from the resource pool and acts as a timer indicating the doubling time of the cell to determine the growth rate and the concentrations of various cellular components in the model.

Virtual Cell Model Able to Mimic Wild-Type E. coli Cell State.

With the virtual cell model we determined the growth rates and cellular composition of the wild-type virtual cell to see whether we can reproduce the experimental cell state. For this, we employed two different strategies to evaluate the prediction capacity of the wild-type virtual cell model. First, we varied the external glucose levels to simulate the virtual cell and next we introduced transcription and translation inhibitors under varying glucose levels to monitor the growth effects.

### Nutrient Limiting Conditions

External glucose concentration for the model was varied from 20 mM to 0.1 mM for each simulation run, without changing other parameters. The time taken for the doubling of DNA concentration was captured as the doubling time of the virtual cell to derive the growth rate. Next, we measured the growth curve of wild-type E. coli grown on M9 minimal medium supplemented with casamino acids and different concentration of carbon source, ranging from limiting level of 0.1 mM to saturating level of 20 mM glucose (FIG. 6(D)). At concentrations of glucose greater than 5 mM, the growth rate of wild-type E. coli is independent of change in glucose concentration. As the glucose concentration was changed to 2.5 mM and 1 mM, the growth rate only slightly changed (FIG. 6(C)). At these concentrations ranging from 1 mM to 20 mM the cells grew exponentially faster resulting in higher growth rates, however the saturation of the growth curve was different between the concentrations due to the availability of external glucose concentration (FIG. 6(D)). The lower the glucose concentration, the faster the saturation of the curve occurred. The growth rate of E. coli was dependent on the change in glucose concentration in the range of 0 to 0.5 mM. The growth rate was reduced to 0.78 doublings per hour at 0.1 mM glucose (FIG. 6(C)). It is to be noted that under exponential growth, the macromolecular composition of a cell through the growth rate depends on the nutrient content of the medium (24). The experimental evidences point out that by increasing the concentration of the carbon source in the medium, increases the growth rate of the cell, which is comparable to earlier reports (20, 52). The predicted and experimental growth rate of the cell under varying glucose concentrations is as shown in FIG. 6(C), showed higher correlation with the experimental data |r|=0.985.

The model also offers the detailed predictions of the composition of the major components in the cell, which are very difficult to investigate experimentally. Previously, many studies have attempted to predict the individual activities of the components like RNA polymerase, ribosomes and protein synthesizing system (19, 20, 48), the virtual cell model can predict the dynamics of all the components such as total and free RNA polymerase/ribosomes available, native RNA and bulk proteins composition, amino acids and nucleotides consumption and the global effects of ppGpp during nutrient starvation periods.

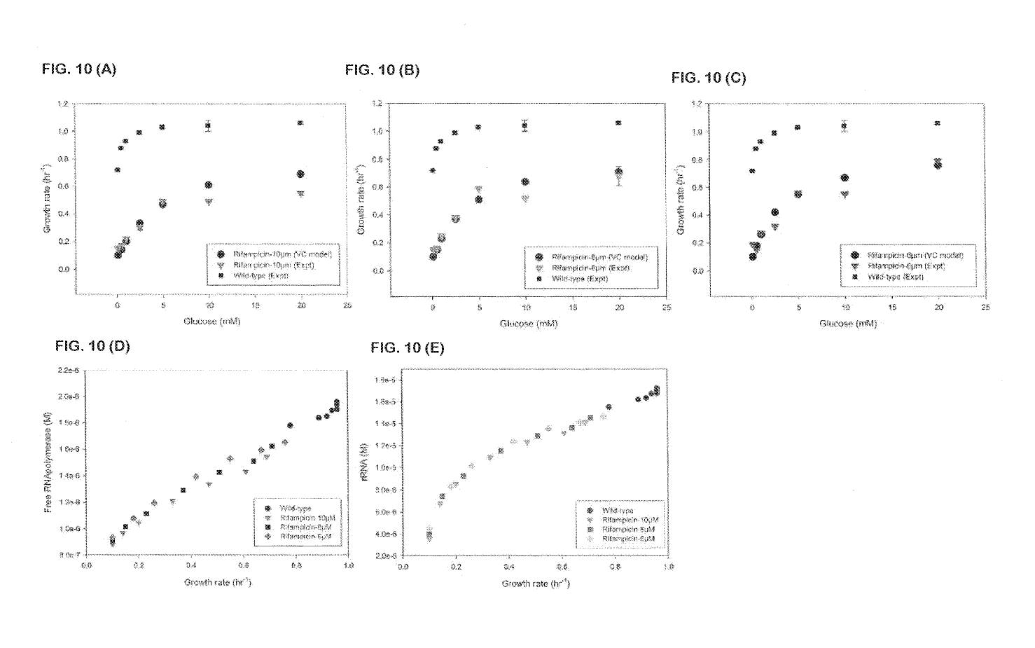

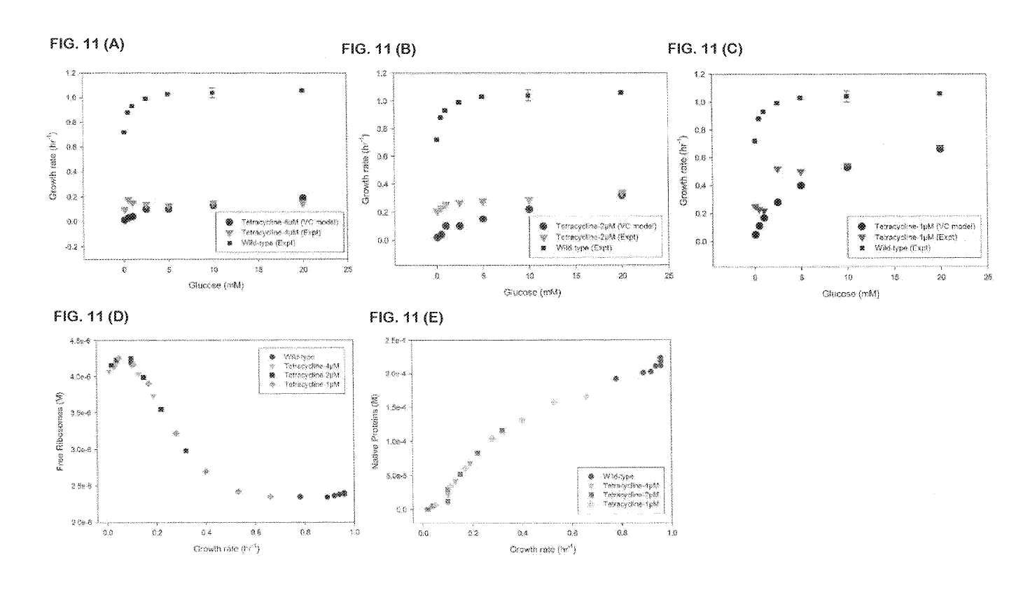

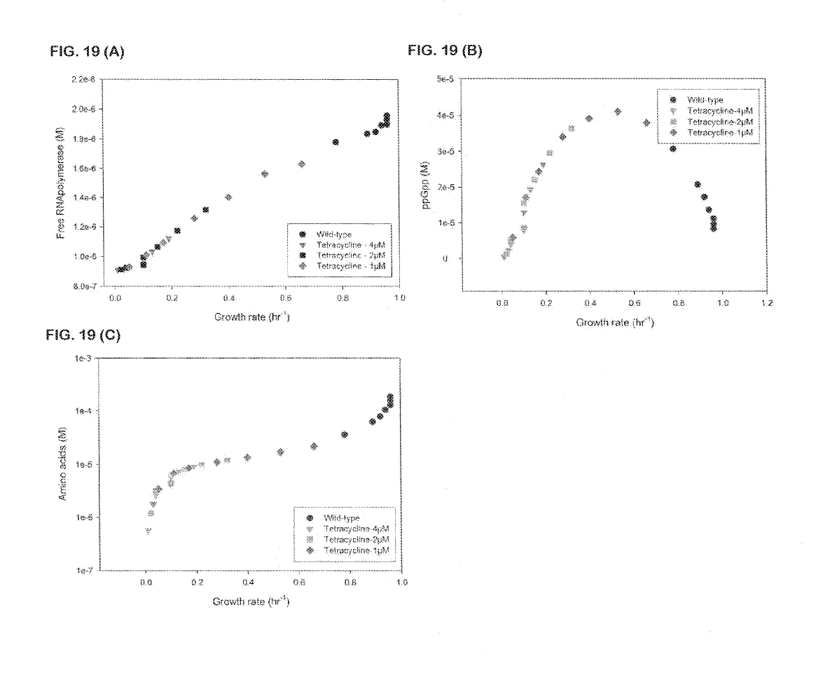

The free RNA polymerase concentration increases with increasing growth rate, which is consistent with the previous prediction studies (19, 53). The free RNA polymerase concentration predicted in a wild-type cell increases from 1.78 μM for a growth rate of 0.78 doublings per hour to 1.96 μM for a growth rate of 0.96 doublings per hour (FIG. 10(D)). The range of total RNA polymerase concentration predicted is substantially similar to the prediction estimate of 7.4 μM made by Bremer et al. for a growth rate of 1.0 doublings per hour, using a model based on the evaluation of the promoter activity data (19). Similarly in FIG. 19 consistent with previous predictions, the current model also demonstrates the saturation of the growth rate dependent free RNA polymerase concentration at higher growth rates (53).

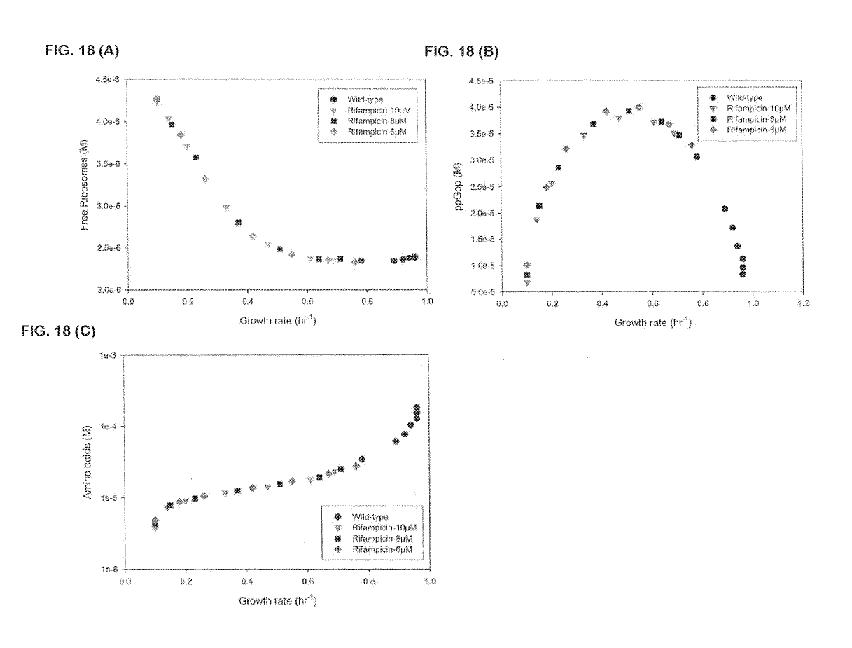

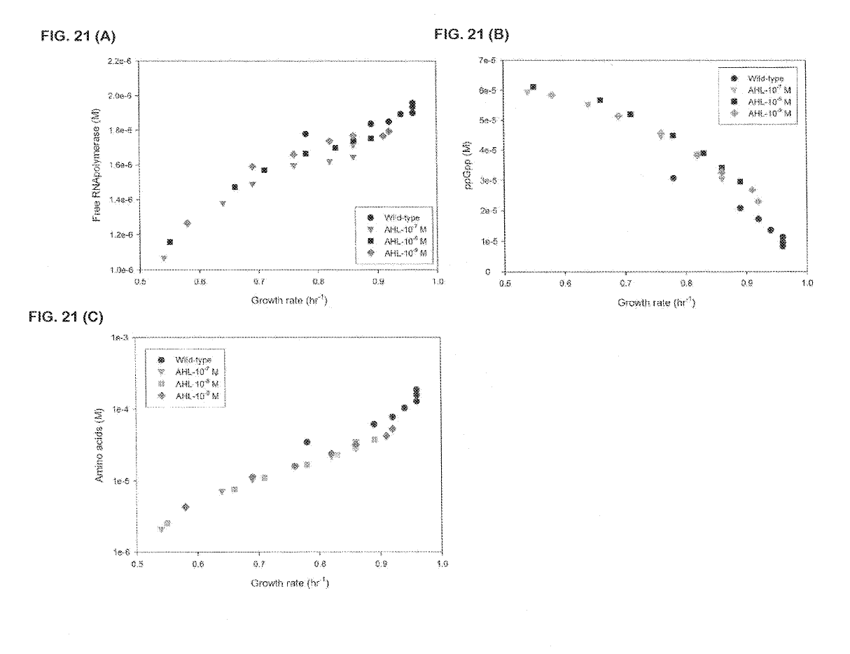

The concentration of free ribosomes was predicted to remain almost constant with increasing growth rate for the wild-type cell (FIG. 11(D)). It has been implied that the pool size of free ribosomes is proportional to rate of protein synthesis and the concentration of proteins across growth rates is found to be constant (24). The predicted concentration of free ribosomes in a wild-type cell was found to be 2.35 μM for a growth rate of 0.96 doublings per hour and 2.39 μM for a growth rate of 0.78 doublings per hour. The rate of growth is set by the macromolecule synthesis machineries such as ribosomes and RNA polymerase and the control of this machinery is based on the availability of pools of monomers which is regulated by a small nucleotide ppGpp (20). Our model incorporating these hypotheses predicts the rRNA synthesis controlled by the ppGpp concentration based on the availability of the monomers. In line with earlier predictions, the computed rRNA concentration as a function of growth rate increased with increasing growth rate (20, 24) as shown in FIG. 10(E). Our model's predictions (FIGS. 18 to 21) recapitulate previous experimental and modelling evidences that increase in ppGpp concentration at low growth rates is a result of limited amino acid pools availability regulating the synthesis of rRNA transcription by binding to free RNA polymerases (20, 54, 55).

### Transcription and Translation Inhibition

Next, in order to validate the predicted growth rate effects when the cellular processes transcription and translation are inhibited, we tested the wild-type E. coli with varying dosages of transcription inhibitor (rifampicin) and translation inhibitor (tetracycline) exposed to varying glucose concentration. In FIGS. 10(A to C) and 11(A to C), we compare the predicted growth rates during transcription and translation inhibition at varying sub-inhibitory doses and glucose concentrations. When transcription is inhibited by rifampicin at 10 μM sub-inhibitory level, the reduction in growth rate at maximum glucose concentration is 0.55 doubling per hour (FIG. 10(A)). As expected, the growth rates increased to 0.68 and 0.79 doublings per hour when the rifampicin concentration was reduced to 8 μM and 6 μM respectively. Similarly, when translation is inhibited by tetracycline at 4 μM sub-inhibitory level, the growth rate reduced significantly to 0.19 doublings per hour (FIG. 11(A)). At tetracycline concentrations of 2 and 1 the growth rate was seen to increase to 0.38 and 0.66 doublings per hour (FIGS. 11(B & C). The wild-type model incorporating the inhibitor parameters closely agrees with the experimental growth rate observations implying a high correlation of average |r|=0.98.

The model also predicts the dynamic response of free RNA polymerase concentration when the virtual cell is subjected to transcription (FIG. 10(D)) and translation inhibition (FIG. 19(A)) independently. During transcription inhibition, the antibiotic rifampicin binds specifically to the free RNA polymerase blocking RNA synthesis (56). The model accounting the RNA polymerase-inhibitor binding at an inhibitor concentration of 10 predicted the decrease in free RNA polymerase concentration from 0.88 μM for a growth rate of 0.1 doublings per hour and 1.54 μM for a growth rate of 0.69 doublings per hour compared to that of a wild-type cell (FIG. 10(D)). This fraction of free RNA polymerase concentration increases 6% with decreasing transcription inhibition concentration of 6 μM at a growth rate of 0.76 doublings per hour. The translation inhibiting antibiotic, tetracycline inhibit bacterial protein synthesis by preventing the association of aminoacyl-tRNA with the bacterial ribosome (43). Likewise, during translation inhibition at an inhibitor concentration of 4 μM the concentration of free RNA polymerase was predicted to decrease from 0.91 μM for a growth rate of 0.01 doublings per hour and 1.12 μM for a growth rate of 0.19 doublings per hour compared to that of a wild-type cell (FIG. 19(A)). Also, note that the range of predicted free RNA polymerase concentration from the model increased with decreasing translation inhibition.

FIG. 18(A) and FIG. 11(D) illustrate the free ribosomes concentration during transcription and translation inhibition respectively. Both during transcription and translation inhibition at lower grow rates, the model predicts increase in free ribosome concentration and gradually reducing with increasing growth rates and maintaining a constant concentration during 0.5 to 1.0 doublings per hour. This prediction from our model corresponds to the conclusion from studies suggesting that there is an excess, unengaged free ribosomes in slow growing cells, i.e., at lower growth rates (37). The range of free ribosomes concentration during transcription inhibition by rifampicin at 10 μM concentration was predicted to be 4.24 μM for a growth rate of 0.1 doublings per hour and 2.35 μM for a growth rate of 0.69 doublings per hour. Likewise, during translation inhibition by tetracycline at 4 μM concentration, the free ribosome concentration was found to be 4.01 μM for a growth rate of 0.01 doublings per hour and 3.73 μM for a growth rate of 0.19 doublings per hour. Furthermore, the transcription and translation inhibition decreases the concentration of both RNA and protein levels which corroborates to the inhibition mechanism of the antibiotics. At lower growth rates, the concentrations of both mRNA and protein levels are lower which increases gradually with increasing growth rate. During transcriptional and translational inhibition, the model predicts the decrease in rRNA concentration due to the inhibitor complex formation with the machineries free RNA polymerase and ribosomes, thereby reducing the synthesis of rRNA (FIG. 10(E)). In the case of protein concentration during translation inhibition, there is increase in concentrations from 0.1 to 0.5 doublings per hour and the levels become constant from 0.5 to higher growth rates (FIG. 11(E)). An interesting find from the model is that the ppGpp and amino acids concentration during the inhibition at lower growth rates was found to be lower and it increases with increasing rRNA synthesis (FIG. 18(B), FIG. 19(B)). For example, during transcription inhibition at 10 μM concentration the ppGpp was predicted to be 6.78 μM at a growth rate of 0.1 doublings per hour. Also, the ppGpp concentration was predicted to be 0.5 μM at a growth rate of 0.1 doublings per hour during translation inhibition at 4 μM concentration. These results highlight the fact that for slow growing cells, ppGpp level is limited due to lower rRNA concentration and it increases until the growth rate reaches a threshold of 0.5 doublings per hour due to limited amino acid pools (FIG. 18(C), FIG. 19(C)). As the rRNA increases with growth rate ppGpp levels drops down from 0.5 doublings per hour due to increased supply of amino acid pools.

### Heterologous Circuits Influence on Host Cell Behaviour

Once we had the validated wild-type virtual cell model, we wanted to determine the impact on the growth of E. coli by expressing unnecessary proteins by constitutive and inducible systems under varying external glucose concentrations.

### Constitutive Gene Expression

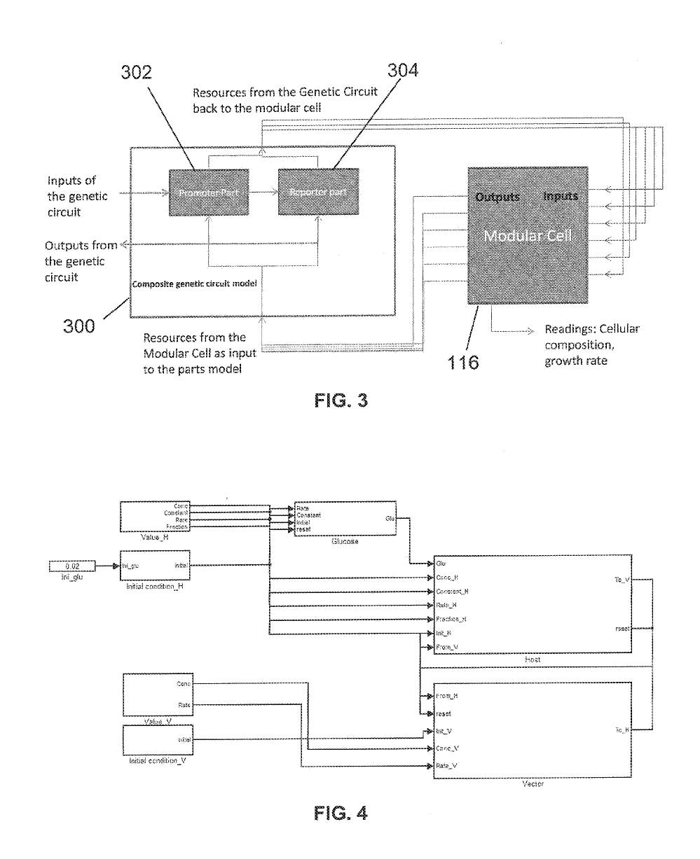

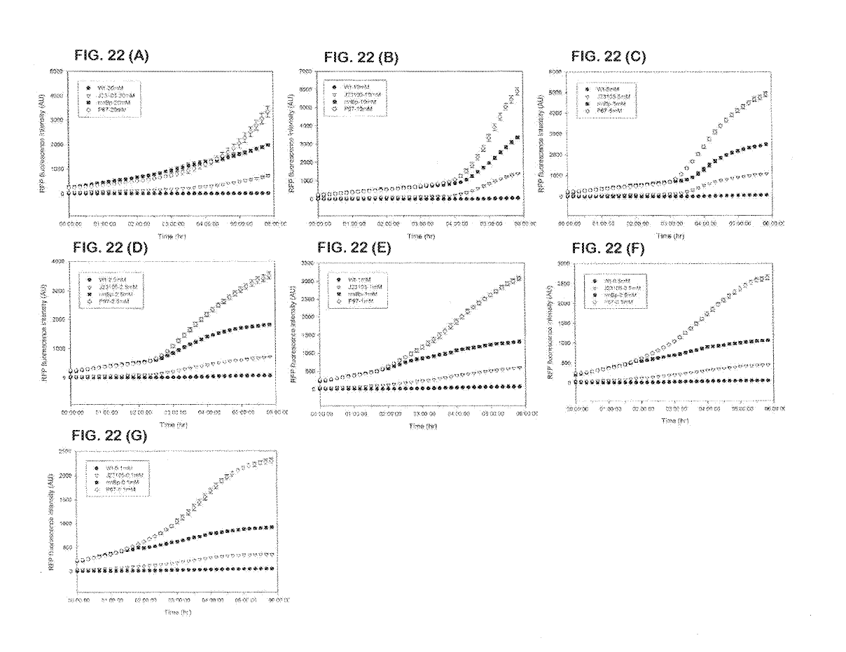

In the experimental analysis, we studied the consequences of expressing the reporter protein RFP in E. coli harbouring pBbE8K with different strength constitutively ON promoters exposed to a range of glucose concentrations. We monitored the dynamic expression at a time resolution of every 10 min for 6 hrs. During exponential growth under nutrient limiting conditions, we find that the promoters have moderate activity (based on their strengths) independent of the glucose levels and during stationary growth or slow growing conditions there is sudden increase in the expression. Decreasing the glucose levels, decreased the RFP expression levels due to lower glucose availability (FIG. 22). Among the promoters tested, maximal expression was observed for P67, followed by rrnB and J23105 promoters FIG. 4(B). The promoter activity was measured by the rate of RFP synthesis per OD₆₀₀ as described above. FIG. 10(C-E) increasing the strength of the promoters decreases the growth of the cell and due to the reduction of the external glucose levels growth rate ceases further in comparison to that of the wild-type cell. When exposed to maximum glucose concentration, the low strength promoter (J23105) showed a drop of 4%, while medium (rrnBp) and high strength (P67) promoter was seen to have 16% and 21% reduction in growth rates. Our virtual cell model reproduced the experimental outcome with high correlation resulting in |r|=0.988 for J23105 and |r|=0.943 for both rrnBp and P67 promoters.

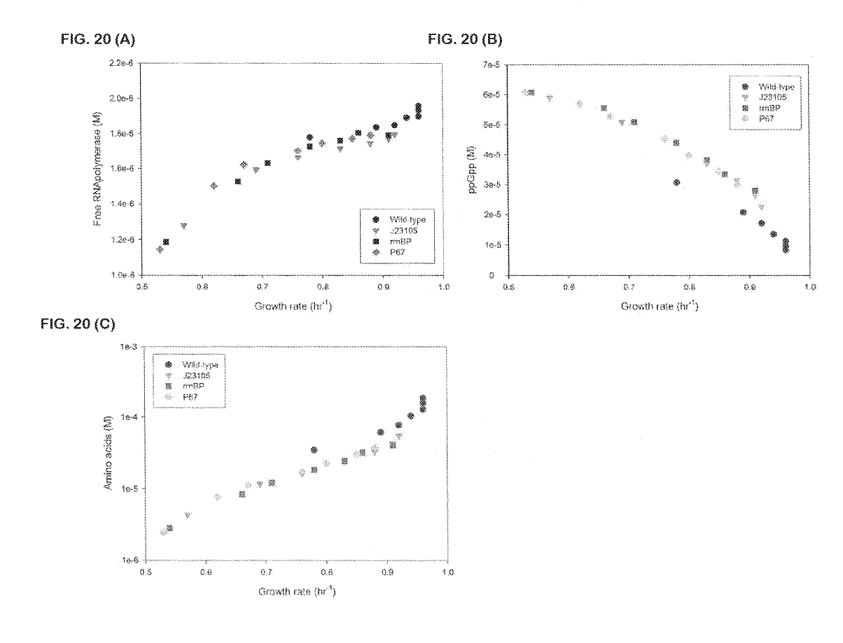

In the scenario of heterologous expression there is significant amount of load on the cellular resources which affects the growth and hence the free RNA polymerase concentration decreases with increased strength of constitutive promoters as shown in FIG. 20(A). When a low strength promoter is heterologously expressed, the free RNA polymerase concentration is predicted to decrease substantially from that of the wild-type cell from 1.28 μM for a growth rate of 0.57 doublings per hour at the lowest glucose concentration and 1.8 μM for a growth rate of 0.92 doublings per hour at the highest glucose concentration. In the case of a medium strength promoter, the predicted free RNA polymerase concentration decreased from 1.18 μM for a growth rate of 0.54 doublings per hour and 1.79 μM for a growth rate of 0.91 doublings per hour. For a high strength promoter, the decrease in free RNA polymerase concentration was predicted to be even higher from 1.14 μM for a growth rate of 0.54 doublings per hour and 1.79 μM for a growth rate of 0.88 doublings per hour compared to that of a wild-type cell.

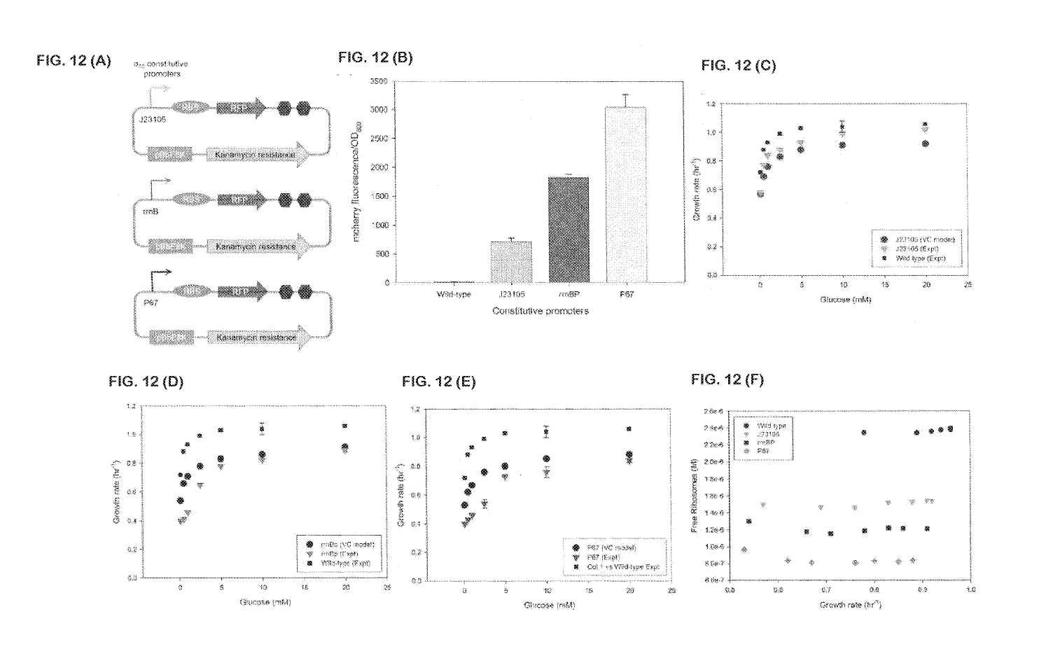

FIG. 12 shows predicted and measured effects of unnecessary protein production on growth by a constitutively expressed gene, under nutrient limiting conditions. (A) We used three constitutively ON promoters (J23105, rrnBp and P67, obtained from BioBricks parts registry) with different promoter strengths expressing RFP (red arrow) at different levels. J23105 is the low strength promoter (RPU=0.3), followed by medium strength rrnBp (native rRNA promoter) which is a standard promoter with an RPU of 1.00 and high strength promoter P67 (RPU=1.4). (B) Characterization of the constitutive promoters based on their expression profile denoted by RFP/OD₆₀₀. (C to E) Growth rate reduction caused by expressing low strength promoter (J23105), medium strength promoter (rrnBp) and high strength promoter (P67). Data were collected from cells harbouring constitutive device placed plasmids with vaying promoter strengths grown in M9 supplemented media with different concentrations of glucose (20 mM-0.1 mM). The model predictions (dark green circles (J23105), dark blue circles (rrnBp) & black circles (P67)) correlated well with our experimental growth rates (light green inverted triangles (J23105), light blue inverted triangles (rrnBp) & red inverted triangles (P67)) resulting in an average |r|=0.966. (F) Concentration of free ribosomes during constitutive gene expression as predicted from our model.

When heterologous expression is introduced into the host it is predicted that, the concentration of free ribosomes decreases from that of the wild-type cell state as shown in FIG. 12(F). It has been proposed that the concentration of free ribosomes plays a major limiting factor in determining the translation yield from a given mRNA (37). For a low strength promoter, the free ribosomes concentration decreases to 36% at a growth rate of 0.92 doublings per hour. In the case of medium and high strength promoters, the free ribosomes concentration accounts for 49% and 65% reduction at growth rates of 0.91 and 0.88 doublings per hour.

### Inducible Gene Expression

The lasQS device used in this study comprised three key components (FIG. 5(A)): the AHL synthetase LasI, the transcription factor LasR, and the lasI promoter. LasI produces the signaling molecule 3-O—C12-HSL (or AHL), and the LasR-AHL complex activates the lasI promoter. First, to examine the characteristics of the lasQS device, we constitutively expressed LasR using a sigma-70 promoter J23105, derived from the BioBrick parts registry (www.partsregistry.org/Part:pSB1K3). The activity of the device was indicated by red fluorescence protein (RFP), which was placed under the control of the lasI promoter. E. coli containing the lasQS device was exogenously exposed to AHL concentrations ranging from 10⁻⁹ M to 10⁻⁷ M and varying glucose concentrations.

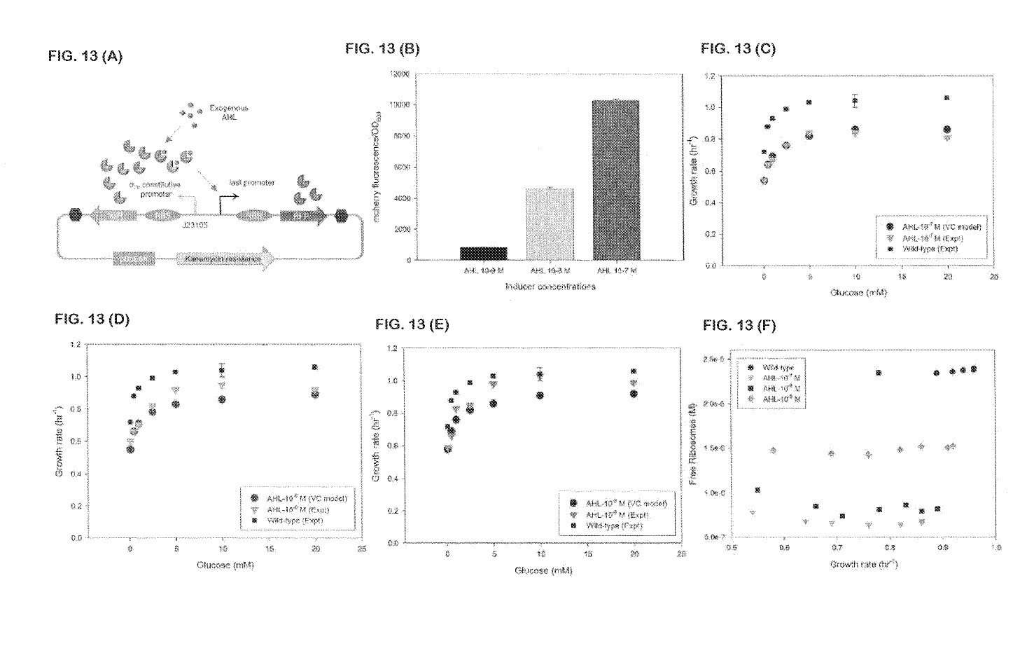

FIG. 13 shows predicted and measured effects of unnecessary protein production on growth by an inducibly expressed gene under limiting nutrient conditions. (A) The inducible device comprises of the promoter (J23105) expressing LasR constitutively. LasR binds to the inducer AHL 3OC₁₂HSL forming, LasR-3OC₁₂HSL complex that activates the lasI promoter leading to the production of the reported protein, RFP (red arrow). All the constructs are carried by the medium copy-number plasmid pBbE8K (green box) with kanamycin resistance (yellow arrow). (B) Characterization of the inducible circuit with varying inducer concentrations resulting on their expression profile denoted by RFP/OD₆₀₀. (C to E) Reduction in growth rate caused by heterologously expressing an inducible device with varying AHL (inducer) concentrations. Data were collected from cells harbouring inducible device placed plasmids grown in M9 supplemented media with different concentrations of glucose (20 mM-0.1 mM) with varying degree of AHL (inducer) concentrations (10⁻⁷-10⁻⁹M). Our model predictions (dark red circles (AHL-10⁻⁷ M), dark green circles (AHL-10⁻⁸ M), dark blue circles (AHL-10⁻⁹M)) correlates well with the experimentally evaluated growth rate dependence of inducible gene expression due to nutrient limitation (green inverted triangles (AHL-10⁻⁷ M), light green inverted triangles (AHL-10⁻⁸ M) & light blue inverted triangles (AHL-10⁻⁹ M)), resulting in an average |r|=0.976. (F) Concentrations of free ribosomes during inducible gene expression as predicted from our model.

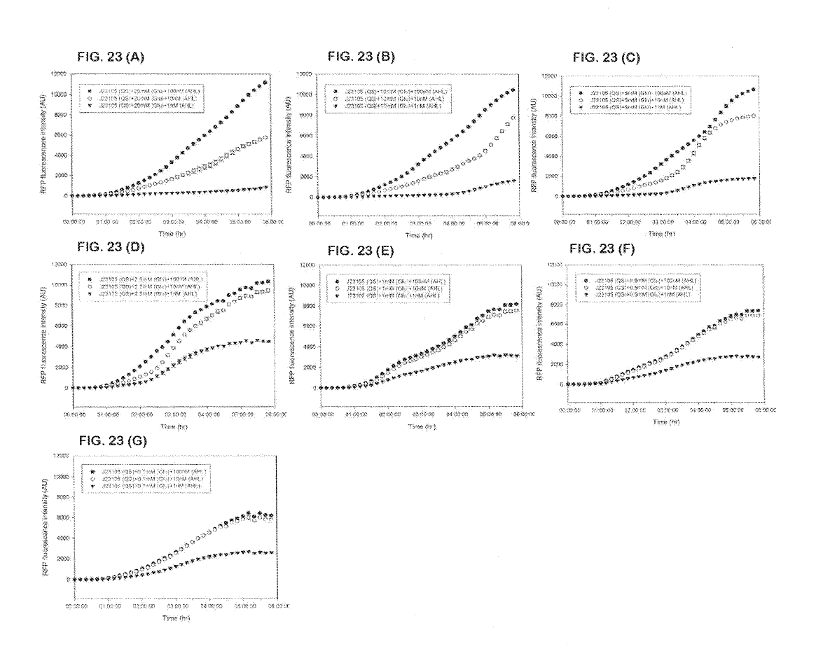

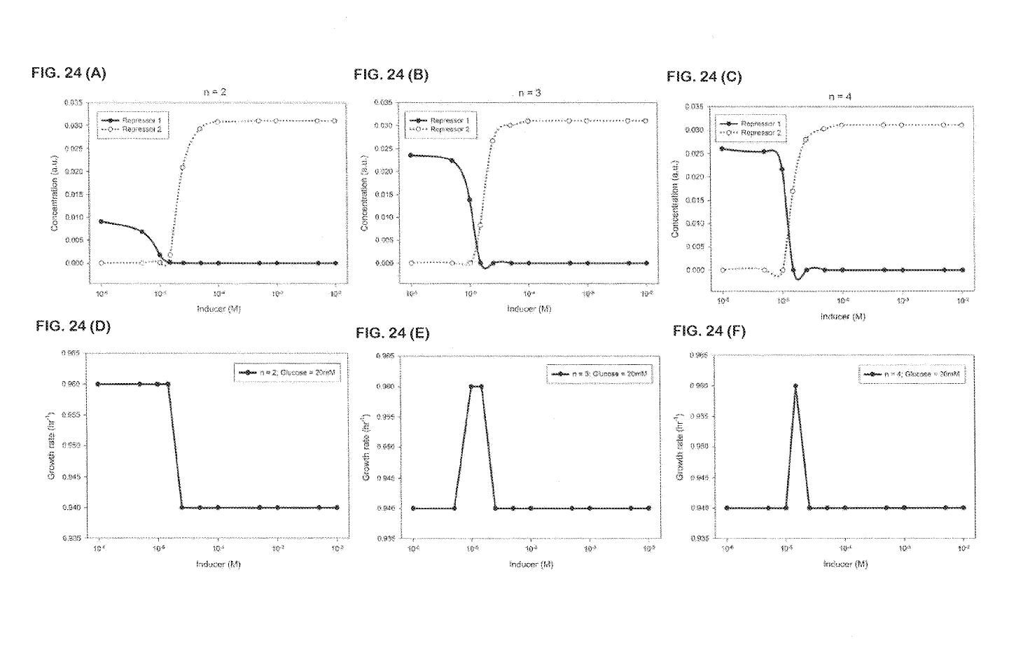

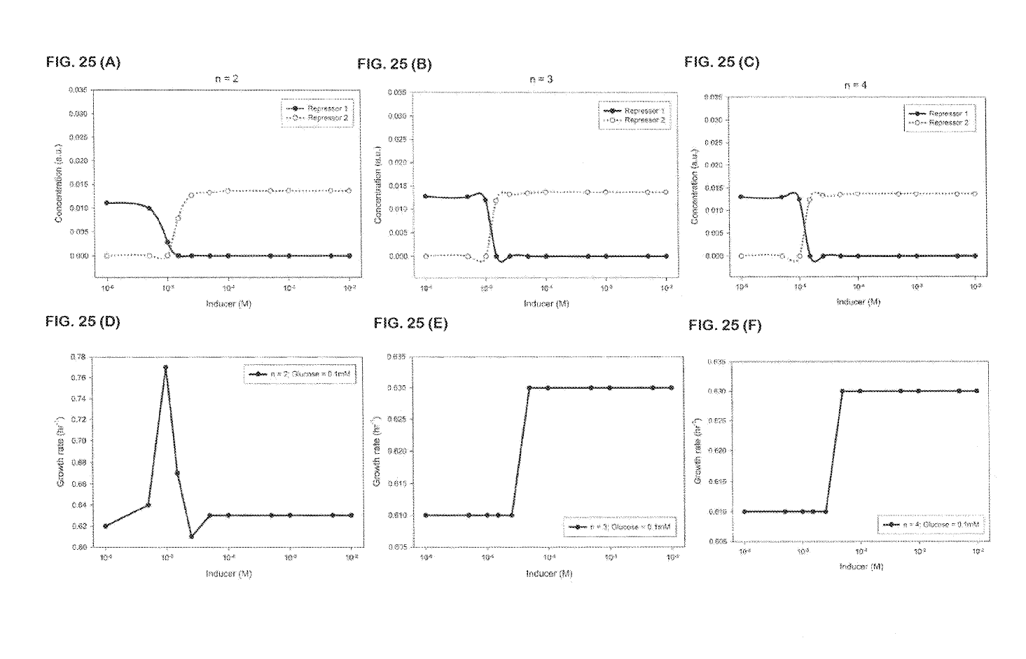

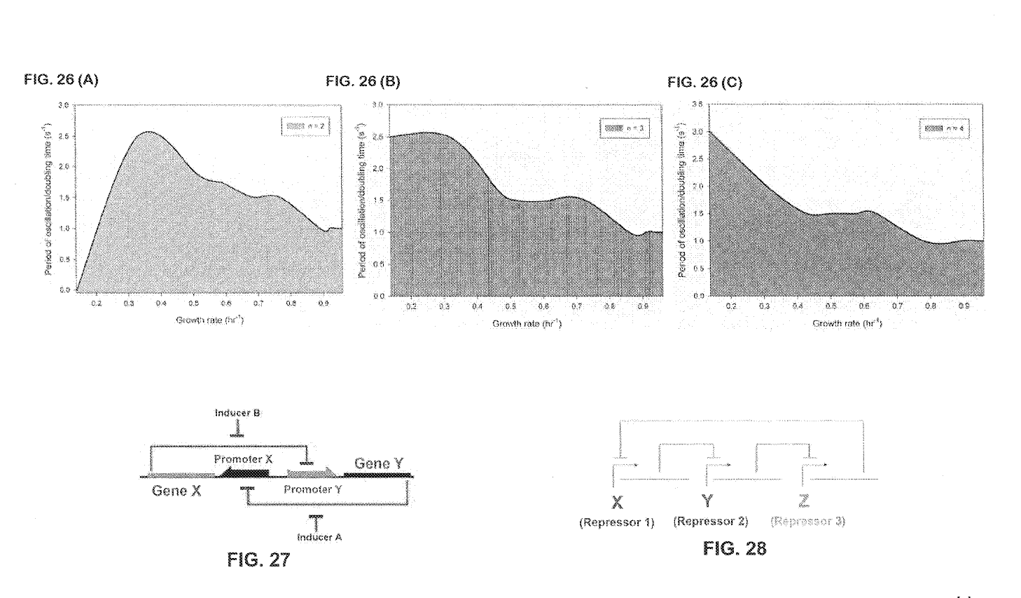

FIG. 23 shows that by increasing the AHL concentrations there is consistently increased output of RFP expression. Increased RFP expression level was found for AHL concentration of 10⁻⁷M and lowest output expression once the nanomolar threshold of AHL concentration is reached (FIG. 13(B)). Similarly, during exponential growth the RFP expression is moderate (based on the inducer level) independent of the glucose levels and during stationary growth or slow growing conditions there is sudden increase in the expression. FIG. 13(C-E) shows that the higher the AHL concentration the lower the growth rate of the cell. At glucose concentration of 20 mM, when AHL is induced at 10⁻⁷ M there is 23% reduction in growth rate which is reduced to 13% and 7% for 10⁻⁸ M and 10⁻⁹M concentrations of AHL. The model was able to predict the drop in the growth rate accumulating the varying inducer and glucose concentration with high correlation of average |r|=0.976. Likewise, the strongest decrease in the free RNA polymerase concentration is seen when higher AHL concentration is used in a host with an inducible device leading to maximal expression levels, and increased inducer concentrations of inducible promoters (FIG. 19(B)). Correspondingly, at low AHL level the free ribosomes concentration was predicted to have a reduction of 36% at a growth rate of 0.92 doublings per hour. The strongest decrease in free ribosomes concentration of 66% and 71% was predicted for higher AHL concentrations of 10⁻⁸ and 10⁻⁷ M. Previous studies have indicated that the expression of heterologous proteins can compete for free ribosomes, reducing the functional number of ribosomes in the native cell and decreasing the expression of other native proteins (9, 57).

### Model Implementation

To demonstrate the use of the virtual cell model, we implemented and tested two well-established synthetic gene circuits such as bistable toggle switch and repressilator in our modelling framework. The main idea here is to identify tuneable experimental parameters to obtain dynamic behaviour of these circuits.

### Bistable Toggle Switch

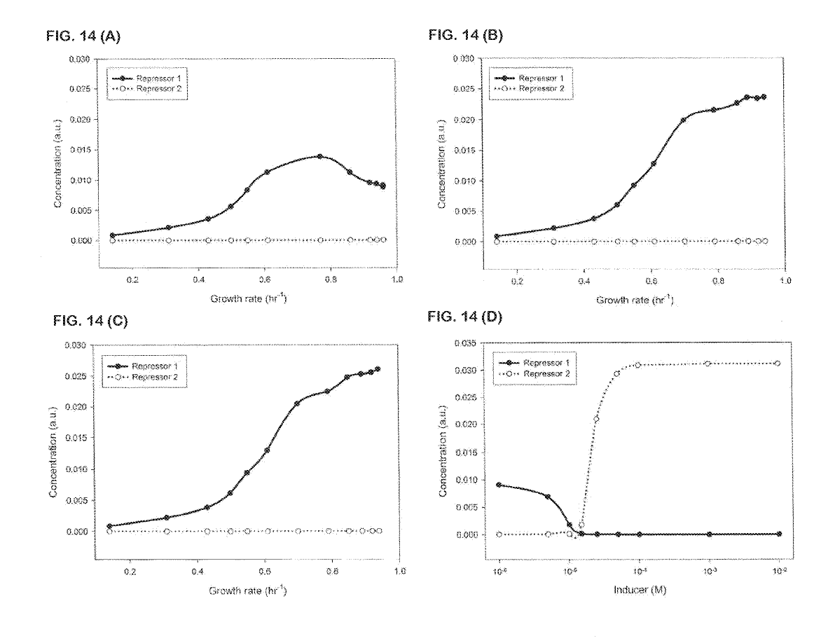

FIG. 14 shows predicted effect of growth rate on bistable toggle switch circuit and induction threshold. (A to C) The plots show the toggle switch dynamics under varying co-operativity of repression, n=2 (A); n=3 (B); n=4 (C). The simulations were run with balanced rates of synthesis and degradation of the repressor mRNA and proteins. The active repressor 1 with the initial condition more the opposing repressor 2, completely inhibits its downstream expression. (D) When the system is induced, with a fixed co-operativity of repression (n=2), external glucose=20 mM, the toggle switches in a quasi-discontinuous manner to the higher state (synthesizing opposing repressor 2 and inhibiting the active repressor 1). This state is maintained for higher inducer levels.

The toggle switch system consists of two repressor genes (constitutive promoters) that mutually repress each other. In this system, two stable states are possible in the absence of the inducers: promoter 1 transcribing repressor 1 and promoter 2 transcribing repressor 2. The states can be switched by transiently introducing the inducer of the currently active repressor. The inducer allows active transcription of the opposing repressor until the originally active repressor is stably repressed (16). We tested the function of the toggle switch circuit by varying the external glucose concentration and coefficient of repression (n≧2), fixing similar transcription/translation rates and degradation rates of the repressors. Our model shows that as growth rate decreases due to limiting nutrient conditions the concentration of the repressors also decreases and for all growth rates the active repressor 1 completely represses the synthesis of the opposing repressor 2 (FIG. 14(A-C)). We then increased the coefficient of repression (n≧2) to study the toggle switch activity, the strongest increase in repression is seen for the higher ‘n’ value (FIG. 14(A-C)). It has been shown that reducing the cooperativity of repression reduces the size of the bistable region (16). Ideally, the toggle system will be pushed to the state of monostability when an inducer is introduced in the model which would alter the dynamic balance between the two promoters. We tested this by introducing the inducer at varying concentrations to revert the repression of the active repressor. The toggle switch induction curve did not have any effect until the inducer concentration of 10 at which point it crosses the bifurcation and exhibits a quasi-discontinous jump to the higher expression rate (FIG. 14(D)). This switching threshold in the toggle circuit behaviour is consistent with the experimental results, which exhibits similar trend (16).

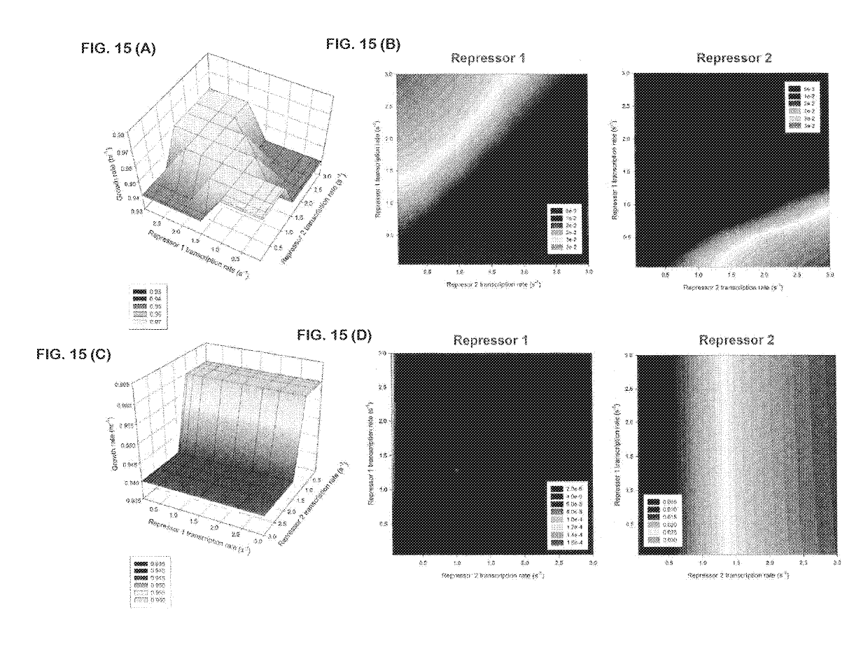

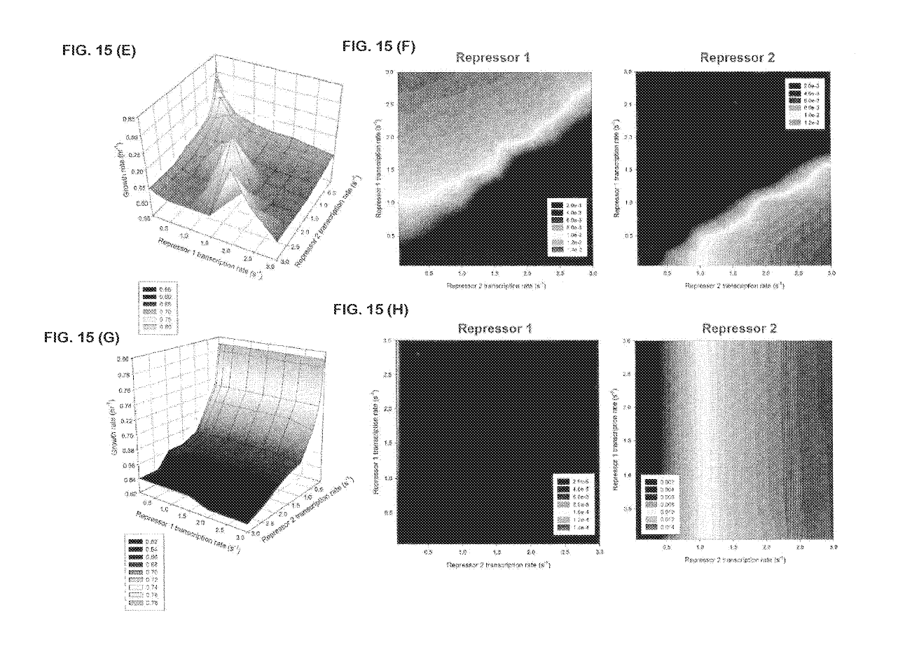

Likewise, the behaviour of the toggle switch and the growth rate of the host cell was tested by varying transcription rates of both the repressors and external glucose concentration (20 & 0.1 mM) (FIG. 15).

FIG. 15 is a demonstration of bistability under varying transcription rates. (A to D) The external glucose maintained in the simulation=20 mM. (E to H) The external glucose maintained in the simulation=0.1 mM. (A) & (E) Growth effect due to varying transcription rates of both the repressors using external glucose at 20 & 0.1 mM respectively. (B) & (F) Levels of repressors when their transcription rates are varied at specified glucose concentrations. (C) & (G) Growth effect by varying the transcription rates of both the repressors when induced using external glucose at 20 & 0.1 mM respectively. The inducer concentration used in the simulation was 1 mM. (D) & (H) Demonstrations of the stability and switching dynamics under varying transcription rates of the repressors at 20 & 0.1 mM glucose respectively. The scale represents the repressor levels.

At higher and low external glucose concentration, the higher the transcription rates of any of the repressor, the higher the synthesis of the corresponding repressor which represses the opposing repressor (FIG. 15). The growth landscape, has a minimal drop from 0.96 doublings per hour to 0.94 doublings per hour at higher glucose concentration. The drop in the growth is at the higher transcription rates of the repressors, which consumes more resources due to the increased synthesis. In the case of low external glucose concentration, the drop in the growth profile is steeper due to limited resources and burden by toggle switch system. Interestingly, the growth profile has discontinuous off-peaks at higher and unequal transcription rates of both the repressors. This behaviour is due to the counter balance effect by mutual repression that happens due to unequal transcription rates of the repressors, thereby recovering back the growth of the cell. When induced, the active repressor 1 is completely inhibited at higher transcription rates of repressor 2 and the toggle state is sustained until very low transcription rate of repressor 2. The growth profile of host in both the external glucose concentration, changes, resulting in lower growth rates at higher transcription rates of repressor 2.

### Repressilator

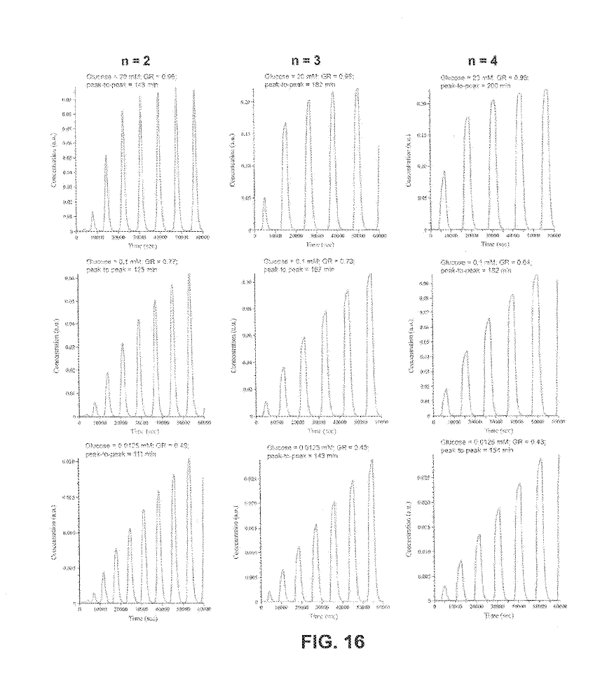

Next, we simulated the repressilator, a ring oscillator consisting of three repressor genes, in which the first repressor protein inhibits the transcription of the second repressor protein, second repressor protein inhibits the transcription of the third repressor protein which in turn inhibits the transcription of the first repressor protein. First, the symmetric repressilator behaviour i.e., the three repressor genes have same transcription/translation rates and degradation rates for both mRNA and proteins was analysed by varying both external glucose concentration and repression strength (hill coefficient, n). Our results show that the symmetric repressilator will increase its oscillatory behaviour at decreasing growth rates and the periodic range estimated by the distribution of the peak-to-peak interval increases with increasing growth rate (FIG. 16).

FIG. 16 shows predicted repressilator dynamics under different growth conditions. Oscillations in the level of the third repressor protein, as obtained from the model. For three different values of the co-operativity of repression, the repressilator was simulated inside the virtual cell at varying glucose concentrations to study the effect on growth and its oscillations (estimated by the distribution of the peak-to-peak intervals). Each of the simulation was run for over a period of 1000 min.

Furthermore, when the coefficient of repression (n≧2) is increased the peak-to-peak interval increases (less oscillatory behaviour) and growth rate of the cell decreases due to higher repression. The predicted repressilator behaviour, i.e., average peak-to-peak distribution is around 160±40 min, which is in excellent agreement with the experimental data of Elowitz et al. (17). We note that, at higher glucose concentration the repressilator device does not affect the growth of the cell, mainly due to the stronger mutual repression of each other and less accumulation as a result of faster degradation rates. At low glucose levels, the growth decreases due to limiting nutrient conditions and on the other hand the change in the characteristics of the repressilator (increase in coefficient of repression), decreases the growth rate of the cell. This observation suggests that the state of the host cell is not only disturbed by the external environment, but also by the deployed circuit's physical characteristics.

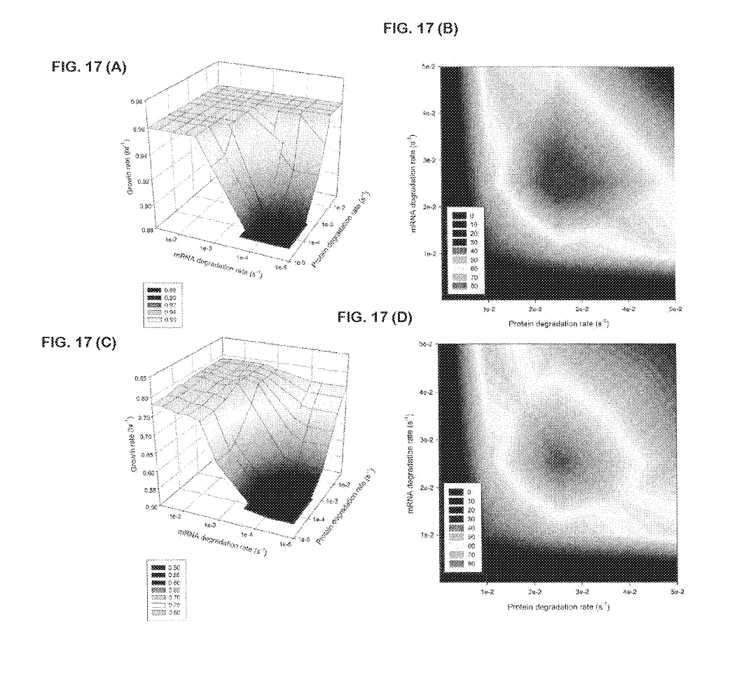

We next used our model to the study the effect of changing the degradation rates of both mRNA and repressor proteins (FIG. 17).

FIG. 17 shows growth and period of oscillations of a symmetric repressilator varying significantly with degradation rates; (A) & (C) Effect on growth due to varying degradation rates of repressor mRNAs and proteins at external glucose concentration of 20 mM and 0.1 mM respectively. (B) & (D) Corresponding period of oscillations due to the variation in the degradation rates of the repressors. Every simulation was run for a period of 1000 min and the total number of oscillations are calculated. The scale represents the number of oscillations within the 1000 min period.

We simulated the model under two different external glucose concentrations. At higher external glucose concentration, the growth rate of the cell (similar to wild-type E. coli) remains stable over a range of faster mRNA and protein degradation rates and at slower degradation rates the growth of the cell is burdened due to higher accumulation of unnecessary mRNA/proteins. Our model predicts that the period of oscillations remains higher at faster degradation rates and loses its oscillatory state at slower degradation rates. We find that, at lower external glucose concentration the growth of the cell (0.79 doublings per hour) is lower compared to that of the higher glucose concentration (0.96 doublings per hour) at similar parameter space. Similar to the previous case, the model shows that the landscape of the growth remains more or less stable under lower glucose concentration and faster degradation rates. We find, that the period of oscillation remains stable even at lower growth rates but, the growth of the cell significantly falls steeply from 0.75 doublings per hour to 0.5 doublings per hour at slower degradation rates.

Embodiments of the host cell simulation system and method presented herein provide the advantage of accelerating predictions of the synthetic circuitry behaviour and the effects of the synthetic circuit inside the host cell environment. Advantageously, the host cell simulation system is able to appropriately predict the host system behaviour which allows engineers to test different synthetic circuits and to observe the cellular behaviour rapidly with less experimental trial and error. Accordingly, integration of the host cell physiology to accurately design and optimize synthetic circuits will ultimately aid in better understanding of their relationships, thereby improving the biological design cycle.

In some embodiments, the host cell simulation method and system may be implemented using ODEs, as described above. However, in some embodiments it may be advantageous to modularize the virtual cell (host) and genetic circuit (vector) with standard inputs and outputs. The inputs and outputs will include the cellular resources such as polymerase, ribosomes etc. as discussed above. The host and the genetic circuit can be visualized using block diagrams and the different blocks can be connected together, using the graphical design component 102 and simulation control component 104 for example, as opposed to modifying ODEs directly. Using this approach, the genetic circuits can be “connected” to the host cell in a standardized way. This will be much more efficient as the models become reusable. Hence, a library of such standardized models for the genetic circuits can be built to facilitate future design and modelling process of the genetic circuits.

### REFERENCES

1. Lee G N & Na J (2013) The Impact of Synthetic Biology. ACS Synthetic Biology 2(5):210-212.
2. Khalil A S & Collins J J (2010) Synthetic biology: applications come of age. Nature reviews. Genetics 11(5):367-379.
3. Tavassoli A (2010) Synthetic biology. Organic & Biomolecular Chemistry 8(1):24-28.
4. Boyle P M & Silver P A (2012) Parts plus pipes: synthetic biology approaches to metabolic engineering. Metabolic engineering 14(3):223-232.
5. Rollie S, Mangold M, & Sundmacher K (2012) Designing biological systems: Systems Engineering meets Synthetic Biology. Chemical Engineering Science 69(1):1-29.
6. Cardinale S & Arkin A P (2012) Contextualizing context for synthetic biology—identifying causes of failure of synthetic biological systems. Biotechnology journal 7(7):856-866.
7. Klumpp S, Zhang Z, & Hwa T (2009) Growth Rate-Dependent Global Effects on Gene Expression in Bacteria. Cell 139(7):1366-1375.
8. Shachrai I, Zaslaver A, Alon U, & Dekel E (2010) Cost of unneeded proteins in E. coli is reduced after several generations in exponential growth. Molecular cell 38(5):758-767.
9. Dong H, Nilsson L, & Kurland C G (1995) Gratuitous overexpression of genes in Escherichia coli leads to growth inhibition and ribosome destruction. Journal of bacteriology 177(6): 1497-1504.
10. Purcell O, Jain B, Karr J R, Covert M W, & Lu T K (2013) Towards a whole-cell modeling approach for synthetic biology. Chaos 23(2).
11. Chandran D, Copeland W B, Sleight S C, & Sauro H M (2008) Mathematical modeling and synthetic biology. Drug Discovery Today: Disease Models 5(4):299-309.
12. Marguet P, Tanouchi Y, Spitz E, Smith C, & You L (2010) Oscillations by Minimal Bacterial Suicide Circuits Reveal Hidden Facets of Host-Circuit Physiology. PLoS ONE 5(7):e11909.
13. Carrera J, Rodrigo G, Singh V, Kirov B, & Jaramillo A (2011) Empirical model and in vivo characterization of the bacterial response to synthetic gene expression show that ribosome allocation limits growth rate. Biotechnology journal 6(7):773-783.
14. Karr J R, et al. (2012) A whole-cell computational model predicts phenotype from genotype. Cell 150(2):389-401.
15. Gramelsberger G (2013) The simulation approach in synthetic biology. Studies in History and Philosophy of Science Part C: Studies in History and Philosophy of Biological and Biomedical Sciences 44(2): 150-157.
16. Gardner T S, Cantor C R, & Collins J J (2000) Construction of a genetic toggle switch in Escherichia coli. Nature 403(6767):339-342.
17. Elowitz M B & Leibler S (2000) A synthetic oscillatory network of transcriptional regulators. Nature 403(6767):335-338.
18. Marchisio M A & Stelling J (2008) Computational design of synthetic gene circuits with composable parts. Bioinformatics 24(17):1903-1910.
19. Bremer H, Dennis P, & Ehrenberg M (2003) Free RNA polymerase and modeling global transcription in Escherichia coli. Biochimie 85(6):597-609.
20. Marr A G (1991) Growth rate of Escherichia coli. Microbiological reviews 55(2):316-333.
21. Dennis P P, Ehrenberg M, & Bremer H (2004) Control of rRNA synthesis in Escherichia coli: a systems biology approach. Microbiology and molecular biology reviews: MMBR 68(4):639-668.
22. Shepherd N, Dennis P, & Bremer H (2001) Cytoplasmic RNA Polymerase in Escherichia coli. Journal of bacteriology 183(8):2527-2534.
23. Lewin B (2000) Genes: VII (Oxford University Press, U K).
24. Bremer H, Dennis, P. P. (1996) Escherichia coli and Salmonella (ASM press, Washington D.C.) 2nd Ed.
25. Muise O & Holler E (1985) Interaction of DNA polymerase I of Escherichia coli with nucleotides. Antagonistic effects of single-stranded polynucleotide homopolymers. Biochemistry 24(14): 3618-3622.
26. Condon C, Squires C, & Squires C L (1995) Control of rRNA transcription in Escherichia coli. Microbiological reviews 59(4): 623-645.
27. Wagner R (2002) Regulation of ribosomal RNA synthesis in E. coli: effects of the global regulator guanosine tetraphosphate (ppGpp). Journal of molecular microbiology and biotechnology 4(3):331-340.
28. Bremer H, Baracchini E, Little R, & Ryals J (1987) Genetics of Translation; New Approaches), Vol 14, p 14.
29. Gausing K (1974) Ribosomal protein in E. coli: Rate of synthesis and pool size at different growth rates. Molec. Gen. Genet. 129(1):61-75.
30. Nomura M (1999) Regulation of Ribosome Biosynthesis in Escherichia coli and Saccharomyces cerevisiae: Diversity and Common Principles. Journal of bacteriology 181(22):6857-6864.
31. Domach M M, Leung S K, Cahn R E, Cocks G G, & Shuler M L (1984) Computer model for glucose-limited growth of a single cell of Escherichia coli B/r-A. Biotechnology and bioengineering 26(3):203-216.
32. Natarajan A & Srienc F (1999) Dynamics of Glucose Uptake by Single Escherichia coli Cells. Metabolic engineering 1(4): 320-333.
33. Natarajan A & Srienc F (2000) Glucose uptake rates of single E. coli cells grown in glucose-limited chemostat cultures. Journal of microbiological methods 42(1):87-96.
34. Varma A, Boesch B W, & Palsson B O (1993) Stoichiometric interpretation of Escherichia coli glucose catabolism under various oxygenation rates. Applied and environmental microbiology 59(8):2465-2473.
35. Pedreno S, Pisco J P, Larrouy-Maumus G, Kelly G, & de Carvalho L P (2012) Mechanism of feedback allosteric inhibition of ATP phosphoribosyltransferase. Biochemistry 51(40):8027-8038.
36. Schneider D A & Gourse R L (2004) Relationship between Growth Rate and ATP Concentration in Escherichia coli: A BIOASSAY FOR AVAILABLE CELLULAR ATP. Journal of Biological Chemistry 279(9): 8262-8268.
37. Jensen K F & Pedersen S (1990) Metabolic growth rate control in Escherichia coli may be a consequence of subsaturation of the macromolecular biosynthetic apparatus with substrates and catalytic components. Microbiological reviews 54(2):89-100.
38. Katayama T (2001) Feedback controls restrain the initiation of Escherichia coli chromosomal replication. Molecular microbiology 41(1):9-17.
39. Potrykus K & Cashel M (2008) (p)ppGpp: still magical? Annual review of microbiology 62:35-51.
40. Denapoli J, Tehranchi A K, & Wang J D (2013) Dose-dependent reduction of replication elongation rate by (p)ppGpp in Escherichia coli and Bacillus subtilis. Molecular microbiology 88(1):93-104.
41. Cooper S & Helmstetter C E (1968) Chromosome replication and the division cycle of Escherichia coli B/r. J Mol Biol 31(3):519-540.
42. Kassavetis G A, Kaya K M, & Chamberlin M J (1978) Escherichia coli RNA polymerase-rifampicin complexes bound at promoter sites block RNA chain elongation by Escherichia coli/RNA polymerase and T7-specific RNA polymerase. Biochemistry 17(26):5798-5804.
43. Chopra I & Roberts M (2001) Tetracycline antibiotics: mode of action, applications, molecular biology, and epidemiology of bacterial resistance. Microbiology and molecular biology reviews: MMBR 65(2):232-260; second page, table of contents.
44. Wehrli W (1977) Kinetic studies of the interaction between rifampicin and DNA-dependent RNA polymerase of Escherichia coli. European journal of biochemistry/FEBS 80(2):325-330.
45. Olson M W, et al. (2006) Functional, biophysical, and structural bases for antibacterial activity of tigecycline. Antimicrobial agents and chemotherapy 50(6):2156-2166.
46. Kelly J R, et al. (2009) Measuring the activity of BioBrick promoters using an in vivo reference standard. Journal of biological engineering 3:4.
47. Klumpp S (2011) Growth-Rate Dependence Reveals Design Principles of Plasmid Copy Number Control. PLoS ONE 6(5): e20403.
48. Tadmor A D & Tlusty T (2008) A coarse-grained biophysical model of E. coli and its application to perturbation of the rRNA operon copy number. PLoS computational biology 4(4): el000038.
49. Thomen P, et al. (2008) T7 RNA polymerase studied by force measurements varying cofactor concentration. Biophysical journal 95 (5): 2423-2433.
50. Gao Y Q, Yang W, & Karplus M (2006) Chapter 13—Thermodynamics and kinetic analysis of F0F1-ATPase. Modern Methods for Theoretical Physical Chemistry of Biopolymers, eds Starikov E B, Lewis J P, & Tanaka S (Elsevier Science, Amsterdam), pp 249-XVI.
51. Magnusson L U, Farewell A, & Nystrom T (2005) ppGpp: a global regulator in Escherichia coli. Trends in microbiology 13(5):236-242.
52. Shehata T E & Marr A G (1971) Effect of nutrient concentration on the growth of Escherichia coli. Journal of bacteriology 107(1):210-216.
53. Klumpp S & Hwa T (2008) Growth-rate-dependent partitioning of RNA polymerases in bacteria. Proceedings of the National Academy of Sciences 105(51):20245-20250.
54. Dalebroux Z D & Swanson M S (2012) ppGpp: magic beyond RNA polymerase. Nature reviews. Microbiology 10(3):203-212.
55. Murray H D, Schneider D A, & Gourse R L (2003) Control of rRNA expression by small molecules is dynamic and nonredundant. Molecular cell 12(1):125-134.
56. Campbell E A, et al. (2001) Structural mechanism for rifampicin inhibition of bacterial ma polymerase. Cell 104(6):901-912.
57. Vind J, Sorensen M A, Rasmussen M D, & Pedersen S (1993) Synthesis of proteins in Escherichia coli is limited by the concentration of free ribosomes. Expression from reporter genes does not always reflect functional mRNA levels. Journal of Molecular Biology 231(3):678-688.
58. Srivatsan A & Wang J D (2008) Control of bacterial transcription, translation and replication by (p)ppGpp. Current opinion in microbiology 11(2):100-105.

1. A synthetic biology design system, comprising:
a model conversion component configured to:
receive genetic circuit data indicative of a user-specified genetic circuit design;
identify, from the genetic circuit data, constituent parts of the genetic circuit design, and the connections between the constituent parts;
obtain mathematical models corresponding to the constituent parts; and
combine the obtained mathematical models into a composite model configured to generate genetic circuit output data based on input data indicative of one or more of: free RNA polymerase concentration, free ribosome concentration and rRNA concentration; and
a host cell simulation module configured to receive, as input, the genetic circuit output data from the composite model, and based on the genetic circuit output data, generate host cell output data representing a physiological state of the host.

2. A synthetic biology design system according to claim 1, wherein the genetic circuit output data are indicative of one or more of: free RNA polymerase concentration; free ribosome concentration; rRNA concentration; nucleotide concentration; and amino acid concentration.

3. A synthetic biology design system according to claim 1 or claim 2, comprising a biological parts repository for storing model data representing respective mathematical models of respective biological parts.

4. A synthetic biology design system according to claim 3, wherein the model conversion component is configured to obtain the models corresponding to the constituent parts by retrieving at least one of said models from the biological parts repository.

5. A synthetic biology design system according to claim 3 or claim 4, wherein the respective mathematical models have standardized inputs and outputs.

6. A synthetic biology design system according to any one of claims 1 to 5, comprising an analysis component for analysing, based on the output data, the performance of the user-specified genetic circuit design.

7. A synthetic biology design system according to any one of claims 1 to 6, further comprising a user interface component configured to receive user input in relation to the user-specified genetic circuit design.

8. A synthetic biology design system according to claim 7, wherein the user input comprises one or more of: a circuit topology; at least one constituent part of the genetic circuit design; and at least one parameter of a model of a constituent part of the genetic circuit design.

9. A synthetic biology design system according to claim 6, wherein the analysis component is configured to, based on the host cell output data, determine whether the genetic circuit design is feasible; and if the design is feasible, to cause an exporter component to generate sequence data indicative of a nucleotide sequence of the genetic circuit design.

10. A synthetic biology design system according to claim 9, wherein the exporter component is communicatively coupled to an oligonucleotide synthesizer which is configured to synthesize an oligonucleotide based on said sequence data.

11. A synthetic biology design system according to any one of claims 1 to 10, wherein the host cell simulation module comprises:
a metabolism component for simulating amino acid and nucleotide production based on input stimulus data representing at least an input glucose concentration;
a transcription component for simulating mRNA and rRNA synthesis based on the simulated nucleotide production;
a translation component for simulating protein and RNA polymerase synthesis based on the simulated amino acid production; and
a replication component for simulating DNA synthesis based on the simulated nucleotide production;
wherein the RNA polymerase synthesis in the translation component is coupled to the rRNA synthesis in the transcription component.

12. A host cell simulation system, comprising:
a metabolism component for simulating amino acid and nucleotide production based on input stimulus data representing at least an input glucose concentration;
a transcription component for simulating mRNA and rRNA synthesis based on the simulated nucleotide production;
a translation component for simulating protein and RNA polymerase synthesis based on the simulated amino acid production; and
a replication component for simulating DNA synthesis based on the simulated nucleotide production;
wherein the RNA polymerase synthesis in the translation component is coupled to the rRNA synthesis in the transcription component.

13. A host cell simulation system according to claim 12, wherein the metabolism component comprises a global regulator component for regulating the simulated rRNA synthesis and simulated DNA synthesis.

14. A host cell simulation system according to claim 13, wherein the global regulator component is simulated ppGpp.

15. A host cell simulation system according to any one of claims 12 to 14, wherein the respective components simulate time-dependent concentrations of amino acids, nucleotides, mRNA, rRNA, proteins, RNA polymerase and DNA.

16. A host cell simulation system according to any one of claims 12 to 15, wherein the components are represented by a system of coupled differential equations.

17. A host cell simulation system according to any one of claims 12 to 16, wherein the simulated mRNA synthesis and/or the simulated protein synthesis are at least partly based on input data received from at least one genetic circuit component.

18. A synthetic biology design method, comprising:
receiving, at at least one computer processor, genetic circuit data indicative of a user-specified genetic circuit design;
identifying, by the at least one computer processor from the genetic circuit data, constituent parts of the genetic circuit design, and the connections between the constituent parts;
obtaining, by the at least one computer processor, mathematical models corresponding to the constituent parts;
combining, by the at least one computer processor, the obtained mathematical models into a composite model configured to generate genetic circuit output data based on input data indicative of one or more of: free RNA polymerase concentration, free ribosome concentration and rRNA concentration; and
inputting the genetic circuit output data from the composite model into a host cell simulation component to generate host cell output data representing a physiological state of a host cell.

19. A synthetic biology design method according to claim 18, wherein the genetic circuit output data are indicative of one or more of: free RNA polymerase concentration; free ribosome concentration; rRNA concentration; nucleotide concentration; and amino acid concentration.

20. A synthetic biology design method according to claim 18 or claim 19, comprising providing a biological parts repository which stores model data representing respective mathematical models of respective biological parts.

21. A synthetic biology design method according to claim 20, wherein obtaining the models corresponding to the constituent parts comprises retrieving at least one of said models from the biological parts repository.

22. A synthetic biology design method according to any one of claims 18 to 21, comprising analysing the performance of the user-specified genetic circuit design.

23. A synthetic biology design method according to any one of claims 18 to 22, further comprising receiving user input in relation to the user-specified genetic circuit design.

24. A synthetic biology design method according to claim 23, wherein the user input comprises one or more of: a circuit topology; at least one constituent part of the genetic circuit design; and at least one parameter of a model of a constituent part of the genetic circuit design.

25. A synthetic biology design system according to claim 22, wherein said analyzing comprises, based on the host cell output data, determining whether the genetic circuit design is feasible; and wherein the method comprises, if the design is feasible, generating sequence data indicative of a nucleotide sequence of the genetic circuit design.

26. A synthetic biology design system according to claim 25, comprising synthesizing an oligonucleotide based on said sequence data.

27. A host cell simulation method, comprising:
generating initial cellular resource data representing respective initial concentrations of free RNA polymerase, free ribosomes and ribosomal RNA;
receiving nutrient data representing at least a time-dependent glucose concentration; and
based on the nutrient data and the initial cellular resource data, determining output cellular resource data representing time-dependent concentrations of cellular resources of the host cell, the cellular resources comprising: free RNA polymerase; free ribosomes; ribosomal RNA; nucleotides; and amino acids.

28. A host cell simulation method according to claim 27, comprising determining a physiological state of the host cell based on the output cellular resource data.

29. A host cell simulation method according to claim 28, wherein the physiological state comprises one or more of: growth rate; cellular composition; cell mass; and metabolism.

30. A host cell simulation method according to any one of claims 27 to 29, comprising:
providing a synthetic genetic circuit component representing a model for a time-dependent concentration of at least one biological molecule, the synthetic genetic circuit component being configured to:
receive the output cellular resource data;
based on the output cellular resource data and the model, determine the time-dependent concentration of the at least one biological molecule; and
determine resource usage data representing decreases in time-dependent concentrations of the cellular resources of the host cell.
